(19) United States
(12) Patent Application Publication
(10) Pub. No.: US 2024/0015811 A1
(43) Pub. Date: Jan. 11, 2024

(54) NETWORK SELECTION BASED ON STANDARDS VARIANT FOR A RADIO ACCESS TECHNOLOGY

(71) Applicant: QUALCOMM INCORPORATED, San Diego, CA (US)

(72) Inventors: Haris ZISIMOPOULOS, London (GB); Lenaig Genevieve CHAPONNIERE, La Jolla, CA (US); Umesh PHUYAL, San Diego, CA (US); Francesco PICA, San Diego, CA (US)

(21) Appl. No.: 18/253,565

(22) PCT Filed: Jan. 5, 2022
(86) PCT No.: PCT/US2022/011349

§ 371 Date: May 18, 2023

(30) Foreign Application Priority Data
Jan. 11, 2021 (GR) 20210100017

(51) Int. Cl. H04W 76/10; H04W 48/02; H04W 76/20

(52) U.S. Cl. CPC H04W 76/10; H04W 48/02; H04W 76/20

(57) ABSTRACT

This disclosure provides systems, methods, and apparatus, including computer programs encoded on computer-readable media, for determining whether a user equipment (UE) and a base station of a radio access network (RAN) configured to operate according to compatible variants of a standardized radio access technology (RAT). In some cases, a standard development organization for a geographic territory may modify a standardized RAT in a way that creates a new variant (also referred to as a forked deviation) of the RAT. Depending on what changes are made, the new variant may be compatible or incompatible with the original standardized RAT. This disclosure enables the UE to determine according to which variant of the RAT the RAN is configured to operate and manage connections to the RAN based whether the UE and the RAN are configured to operate according to compatible variants of the RAT.

### CROSS-REFERENCE TO RELATED APPLICATIONS

The present Application is a 371 national stage filing of International PCT Application No. PCT/US2022/011349 by ZISIMOPOULOS et al. entitled “NETWORK SELECTION BASED ON STANDARDS VARIANT FOR A RADIO ACCESS TECHNOLOGY,” filed Jan. 5, 2022; and claims priority to Greece Patent Application No. 20210100017 by ZISIMOPOULOS et al. entitled “NETWORK SELECTION BASED ON STANDARDS VARIANT FOR A RADIO ACCESS TECHNOLOGY,” filed Jan. 11, 2021, each of which is assigned to the assignee hereof, and each of which is expressly incorporated by reference in its entirety herein.

### TECHNICAL FIELD

Aspects of the present disclosure relate generally to wireless communications and standard specifications for a radio access technology (RAT).

### DESCRIPTION OF THE RELATED TECHNOLOGY

Wireless communication systems are widely deployed to provide various types of communication content such as voice, video, packet data, messaging, broadcast, and so on. These systems may be capable of supporting communication with multiple users by sharing the available system resources (for example, time, frequency, and power). A wireless communication system may include one or more base stations or one or more network access nodes, each simultaneously supporting communication for multiple communication devices, which may be otherwise known as user equipment (UE). Different base stations or network access nodes may implement different radio communication protocols including fourth-generation (4G) systems such as Long Term Evolution (LTE) systems, LTE-Advanced (LTE-A) systems, or LTE-A Pro systems, and fifth-generation (5G) systems which may be referred to as New Radio (NR) systems. NR, which also may be referred to as 5G for brevity, is a set of enhancements to the LTE mobile standard promulgated by the Third Generation Partnership Project (3GPP).

The 3GPP is collective of several telecommunications standard development organizations that represent different geographic territories. A goal of the 3GPP is to develop a globally consistent standard specification for wireless communication. Each standard development organization may adopt the 3GPP standard specification for use in their respective geographic territories. In some cases, a standard development organization for a geographic territory may choose to modify the 3GPP standard specification in a way that creates a new variant (also referred to as a forked deviation) of the 3GPP standard specification.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method of wireless communication by a user equipment (UE). The method may include receiving indicia that indicates whether a first base station is configured to operate according to a first variant of a first radio access technology (RAT) or a second variant of the first RAT. The method may include establishing a wireless connection with the first base station when both the UE and the first base station are configured to operate according to a same one of the first variant or the second variant.

In some implementations, the first RAT is a 5G New Radio (5G NR) access technology. The first variant may be compatible with a 3rd Generation Partnership Project (3GPP) standards specification for the 5G NR access technology. The second variant may be a forked deviation of the first variant. The second variant may be based on a standards specification that is partially incompatible with the 3GPP standards specification for the 5G NR access technology.

Another innovative aspect of the subject matter described in this disclosure can be implemented in UE. The UE may include at least one modem for wireless communication with a first base station. The modem may be configured to obtain indicia that indicates whether the first base station is configured to operate according to a first variant of a first radio access technology (RAT) or a second variant of the first RAT. The UE may include a processor configured to cause the at least one modem to establish a wireless connection with the first base station when both the UE and the first base station are configured to operate according to a same one of the first variant or the second variant.

Another innovative aspect of the subject matter described in this disclosure can be implemented in a method of wireless communication by a base station. The method may include transmitting indicia that indicates whether the base station is configured to operate according to a first variant of a first radio access technology (RAT) or a second variant of the first RAT. The method may include establishing a wireless connection with the UE when both the UE and the base station are configured to operate according to a same one of the first variant or the second variant.

Another innovative aspect of the subject matter described in this disclosure can be implemented in a base station. The base station may include at least one modem configured to output indicia that indicates whether the base station is configured to operate according to a first variant of a first radio access technology (RAT) or a second variant of the first RAT. The base station may include a processor configured to establish a wireless connection with a user equipment (UE) via the at least one modem when both the UE and the base station are configured to operate according to a same one of the first variant or the second variant.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a pictorial diagram conceptually illustrating an example of a wireless communication system.

FIG. 2 shows a block diagram conceptually illustrating an example of a base station (BS) in communication with a user equipment (UE).

FIG. 3 shows a block diagram conceptually illustrating a wireless communication system in which an example UE may perform a cell selection procedure based on a radio access technology (RAT).

FIG. 4 shows a block diagram conceptually illustrating an example wireless communication system in which a UE may roam to an area of a public land mobile network (PLMN) that is configured to operate according to an incompatible variant of a first RAT.

FIG. 5 shows a message flow diagram conceptually illustrating examples of how a UE may perform cell selection based on a standards variant implemented at a base station.

FIG. 6A shows an example data structure for storing compatibility information regarding a PLMN.

FIG. 6B shows an example data structure for storing compatibility information based on mobile country codes (MCCs).

FIG. 7 shows a conceptual diagram of an example message that may be used to share or discover which standards variant of a RAT is implemented by a radio access network (RAN).

FIG. 8 shows a flowchart illustrating an example process for wireless communication by a UE based on a variant of a RAT implemented by a base station.

FIG. 9 shows a flowchart illustrating an example process for wireless communication by a base station based on a variant of a RAT implemented by the base station.

FIG. 10 shows example indicia that can indicate a variant of a RAT implemented by the base station.

FIG. 11A shows a flowchart illustrating an example process in which a UE determines a variant of a RAT implemented by a base station based on a system information broadcast (SIB) message.

FIG. 11B shows a flowchart illustrating an example process in which a UE determines a variant of a RAT implemented by a base station based a radio resource control (RRC) message.

FIG. 11C shows a flowchart illustrating an example process in which a UE determines a variant of a RAT implemented by a base station based on identification information of the RAN.

FIG. 12A shows a flowchart illustrating an example process in which a base station indicates a variant of a RAT implemented by the base station using system information broadcast (SIB) message.

FIG. 12B shows a flowchart illustrating an example process in which a base station rejects a connection request from a UE that implements an incompatible variant of the RAT.

FIG. 13 shows a flowchart illustrating an example process in which a core network rejects a connection request from a UE that implements an incompatible variant of the RAT.

FIG. 14 shows a block diagram of an example wireless communication device.

FIG. 15 shows a block diagram of another example wireless communication device.

FIG. 16 shows a block diagram conceptually illustrating an example scenario in which a UE travels to a geographic region that implements an incompatible variant of a 5^{th} generation New Radio RAT.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving radio frequency signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

A wireless communication system (which also may be referred to as a wireless communication network) may include one or more radio access networks (RANs) that provide access for a user equipment (UE) to communicate with other nodes in the wireless communication system. A RAN, sometimes also referred to as a radio network, or access network, may include a number of base stations (B Ss) that can support communication for a number of user equipment (UEs). Different types of base stations may be referred to as a NodeB, an LTE evolved NodeB (eNB), a next generation NodeB (gNB), an access point (AP), a radio head, a transmit-receive point (TRP), among other examples, depending on the radio access technology (RAT) that the base station supports. A RAT also may be referred to as a radio technology, an air interface, among other examples. 5G New Radio (5G NR, sometimes referred to a “5G” for brevity) and LTE are examples of different types of RATs. One or more LTE base stations (eNBs) may make up an LTE radio access network (RAN). Similarly, one or more 5G base stations (gNBs) may make up a 5G New Radio (NR) RAN. The RAT may be defined by a standards development organization. The 3GPP is collective of several standard development organizations that work together to develop a globally consistent standard specification for various types of RATs, among other aspects of wireless communication. The 3GPP specification for a RAT may be referred to as a first standards compliant version or a first variant of the RAT. When a standard development organization (SDO) for a particular geographic territory (which also may be referred to as a geographic region or a geographic area) creates and adopts a forked deviation of the 3GPP standard specification, the forked deviation may be referred to as a second standards compliant version or a second variant of the RAT. For example, the second variant may be adopted for use in that particular geographic territory. Thus, the first variant and the second variant of the RAT may be similar, but not wholly consistent. A UE that travels to a geographic territory may expect the RAN to operate according to the first variant but may discover that the RAN is configured to operate according to an incompatible variant of the RAT. The UE may experience degradation of service, failed connections, or delay in selecting a RAN that operates according to a compatible variant of the RAT.

This disclosure provides systems, methods, and apparatus, including computer programs encoded on computer-readable media, for managing connections with a RAN based on whether a UE and the RAN implement compatible standards compliant versions of a RAT. For brevity, this disclosure may refer to standards compliant versions as variants, and the terms may be used interchangeably. A base station that is configured to operate according to a variant may be referred to as implementing that variant, such that a base station that implements the variant will format and process communications to or from a UE in accordance with the standards specification for that variant. Depending on what changes are adopted in a particular variant implemented by RAN, the variant may be compatible or incompatible with a variant implemented by the UE. In some implementations, compatible variants are those which implement the same standards compliant version of the RAT. A UE may receive indicia that indicates whether a base station of a RAN implements a first variant of a RAT or a second variant of the RAT. In some implementations, a base station may transmit a broadcast message (such as a system information block (SIB) message) that includes indicia indicating whether the RAN supports a particular variant of the RAT. Alternatively, or additionally, a UE may determine whether a RAN implements a compatible variant of the RAT based on indicia detected during a connection attempt with the base station. Whether determined by a SIB message element or indicia during the connection attempt (or both), the UE may determine whether the UE and the base station implement compatible variants of the RAT. In some implementations, the UE may maintain a history of which base stations (or which RANs) implement compatible variants of the RAT. The UE may refrain from selecting base stations of a RAN that implements an incompatible variant of the RAT.

In some implementations, a RAN may provide information to a UE that the UE can use to determine whether the RAN supports a variant of the RAT that is compatible with the UE. As an example, a UE that implements a first variant of the RAT promulgated by the 3GPP may be referred to as a 3GPP UE. A UE that implements a second variant of the RAT promulgated by a different standard development organization may be referred to as a non-3GPP UE. Similarly, a 5G base station (gNB) that implements the first variant of the 5G NR RAT may be referred to as a 3GPP gNB and a 5G base station that implements the second variant of the 5G NR RAT may be referred to as a non-3GPP gNB. A 3GPP UE may determine that the base station is a non-3GPP gNB. The 3GPP UE may refrain from a 5G NR connection with the non-3GPP gNB. In some implementations, the 3GPP UE also may blacklist any other base stations associated with the RAN that includes the non-3GPP gNB. The 3GPP UE may consider a different RAN. If the different RAN supports the 3GPP variant of the 5G NR RAT, the 3GPP UE may establish a connection with the 3GPP gNB of the different RAN. Alternatively, or additionally, the 3GPP UE may select a different RAN that supports a 2G, 3G or 4G RAT that supports a 3GPP variant of those RATs.

As described herein, a base station may broadcast a system configuration message or other broadcast message that carries indicia indicating whether the base station supports a particular variant of the RAT. For example, the base station may transmit a message having a SIB that includes a field that indicates a particular variant of the RAT. In some examples, the field may indicate that the base station uses a non-3GPP variant of the RAT. When the field is present, the UE can quickly determine whether the base station (and the RAN that includes that base station) implements a first variant (such as a 3GPP variant) or a second variant (such as a non-3GPP variant) of the RAT based on the contents of the field. When the field is not present, the UE may use a different technique described herein to determine whether the base station implements the first variant or the second variant of the RAT.

In some implementations, a UE may attempt a wireless connection with a base station to determine whether the base station supports a compatible variant of the RAT. For example, when a UE attempts the wireless connection, the UE may use radio resource control (RRC) messaging to request a connection and may receive RRC messaging from the base station. In some implementations, the base station may determine a variant of the RAT implemented by the UE (for example, based on capability indicator(s) in an RRC signaling message or a lookup in a database of a home network for the UE, among other examples). When the base station determines that the UE implements an incompatible variant, the base station may transmit an RRC rejection message or an RRC redirection message. The RRC rejection message may include a reject cause indicating that the base station supports an incompatible variant. In some implementations, the RRC redirection message may indicate a different base station or different RAN that implements a variant of the RAT that is compatible with that of the UE.

In some implementations, the UE may detect other indicia that the base station implements an incompatible variant of the RAT based on contents of an RRC message from the base station. For example, during a connection setup procedure, the base station may transmit an RRC configuration message to the UE. If the RRC configuration message includes settings for a feature defined in the second variant but not defined in the first variant, the UE may determine that the base station implements the second variant. If the UE does not support the second variant, the UE may disconnect from that base station. The UE may blacklist that base station (and optionally, also blacklist other base stations of that RAN) from further connection attempts. For example, when a 3GPP UE receives an RRC configuration messaging having a setting for a non-3GPP feature of a non-3GPP 5G NR RAT, the 3GPP UE may determine that the base station is a non-3GPP gNB. The 3GPP UE may refrain from further connection attempts with that base station. In some implementations, the 3GPP UE may assume that all other base stations of that RAN implement the non-3GPP 5G NR RAT. To prevent unnecessary connection attempts, the 3GPP UE may blacklist that RAN and may instead attempt to establish at wireless connection with an LTE RAN.

In some implementations, a UE may be a 3GPP UE that is roaming in a geographic territory that implements a non-3GPP variant of the 5G NR RAT. The 3GPP UE may determine that it is roaming in that geographic territory based on location-based data (such as from a Global Positioning System (GPS), a regional navigation satellite system (RNSS), or an India Regional Navigation Satellite System (IRNSS), among other examples). Alternatively, the 3GPP UE may determine that it is roaming in that geographic territory based on a network identifier or broadcast network parameters. Examples of such network identifiers or network parameters may include a public land mobile network (PLMN) identifier (ID) or a mobile country code (MCC), among other examples. In some implementations, the UE may store a list that includes one or more PLMN IDs or MCCs that implement an incompatible variant of a RAT implemented by the UE. In some implementations, the network identifiers or network parameters and their respective RAT variant may be referred to as compatibility information. The compatibility information may be stored in a memory of the UE, such as in a subscriber information module (SIM) or other memory. Upon roaming to a geographic territory that requires an incompatible variant of the 5G NR RAT, the UE may refrain from selecting a RAN for the 5G NR RAT. Instead, the UE may perform a network selection/reselection procedure to establish a wireless connection with a 4G RAN that supports a standards compliant implementation of LTE.

In some implementations, a core network associated with the incompatible 5G NR RAT may reject a UE's registration request with a 5G mobility management (5GMM) cause code that informs the UE that the UE is in a geographic territory that implements an incompatible variant of the 5G NR RAT. For example, the UE may be associated with a Home Public Land Mobile Network (HPLMN). When the UE performs a non-access stratum (NAS) registration procedure with a Visiting PLMN (referred to as VPLMN), the VPLMN may contact the HPLMN to determine whether the UE has a subscription for the service. The VPLMN may determine that the UE is associated with an HPLMN that implements a different variant of the 5G NR RAT than is implemented by the VPLMN. Thus, the VPLMN may implement an incompatible variant of the 5G NR RAT than the UE supports. In some implementations, the VPLMN may reject the NAS registration request to prevent the UE from using the incompatible variant of the 5G NR RAT. Additionally, or alternatively, the VPLMN may transmit a NAS registration rejection message that indicates an MCC (or a list of MCCs) that implement the incompatible variant of the 5G NR RAT so that the UE can refrain from selecting a 5G NR RAT for that VPLMN (or other VPLMNs in that geographic territory). Upon receiving the NAS registration rejection message, the UE may obtain service from a different RAT and may refrain from attempting to connect to the RAT from which the UE received the NAS registration rejection message. In some implementations, the NAS registration rejection message may indicate whether the UE should refrain from connecting to that RAT based on a duration of time, until power-cycle, SIM removal, or permanently, among other example conditions.

Particular implementations of the subject matter described in this disclosure can be implemented to realize one or more of the following potential advantages. A RAN may prevent wireless connection attempts from a UE that implements an incompatible variant of a RAT, which may save airtime and network resources. Similarly, a UE may avoid service degradation or failed connection attempts with a RAN that implements an incompatible variant of the RAT. When explicit signaling is used, the UE and base station may prevent an unsuccessful connection attempt before the attempt is made. Alternatively, or additionally, implicit detection of particular variant of a RAT may enable a UE or a base station to quickly discover that the UE and the base station implement incompatible variants of the RAT. User experience may be improved by avoiding delays or possible lack of connectivity that may otherwise occur because of an incompatibility between the UE and base station.

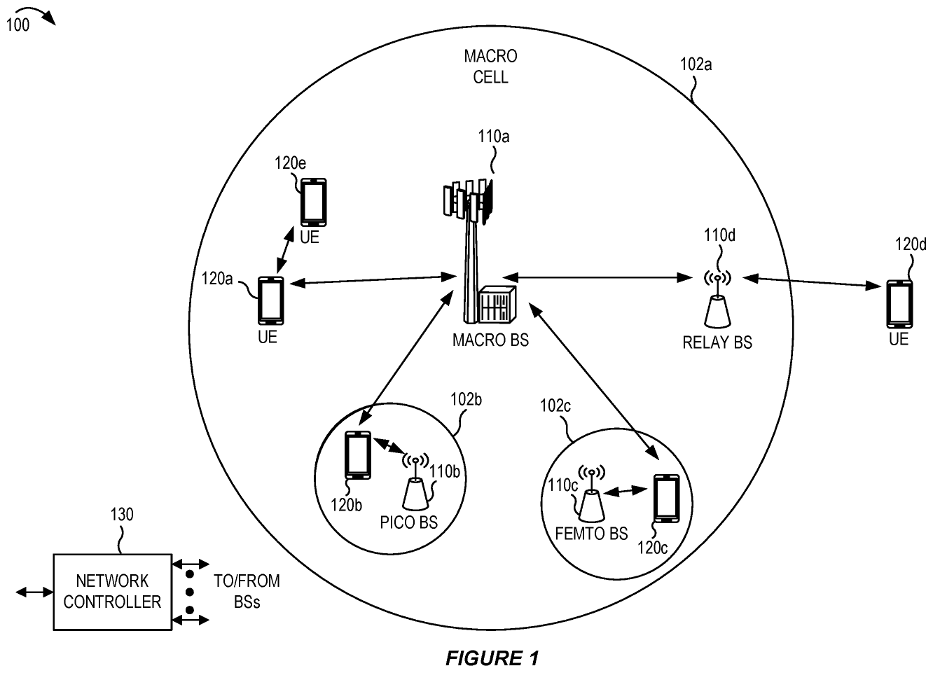

FIG. 1 is a block diagram conceptually illustrating an example of a wireless communication system 100. The wireless communication system 100 may include an LTE RAN or some other RAN, such as a 5G or NR RAN. The wireless communication system 100 may include a number of BSs 110 (shown as BS 110a, BS 110b, BS 110c, and BS 110d) and other network entities. ABS is an entity that communicates with user equipment (UEs) and also may be referred to as a base station, a NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS, a BS subsystem serving this coverage area, or a combination thereof, depending on the context in which the term is used. A UE may communicate with a base station via the downlink (DL) and uplink (UL). The DL (or forward link) refers to the communication link from the BS to the UE, and the UL (or reverse link) refers to the communication link from the UE to the BS.

A BS may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another as well as to one or more other BSs or network nodes (not shown) in the wireless communication system 100 through various types of backhaul interfaces, such as a direct physical connection, a virtual network, or a combination thereof using any suitable transport network.

The wireless communication system 100 also may include relay stations. A relay station is an entity that can receive a transmission of data from an upstream station (for example, a BS or a UE) and send a transmission of the data to a downstream station (for example, a UE or a BS). A relay station also may be a UE that can relay transmissions for other UEs. In the example shown in FIG. 1, a relay station 110d may communicate with macro BS 110a and a UE 120d in order to facilitate communication between BS 110a and UE 120d. A relay station also may be referred to as a relay BS, a relay base station, or a relay, among other examples.

The wireless communication system 100 may include a heterogeneous network that includes BSs of different types, for example, macro BSs, pico BSs, femto BSs, relay BSs, among other examples. These different types of B Ss may have different transmit power levels, different coverage areas, and different impacts on interference in wireless communication system 100. For example, macro BSs may have a high transmit power level (for example, 5 to 40 Watts) whereas pico BSs, femto BSs, and relay BSs may have lower transmit power levels (for example, 0.1 to 2 Watts).

A network controller 130 may couple to a set of BSs and may provide coordination and control for these BSs. The network controller 130 may communicate with the BSs via a backhaul. The B Ss also may communicate with one another, for example, directly or indirectly via a wireless or wireline backhaul.

UEs 120 (for example, 120a, 120b, 120c) may be dispersed throughout wireless communication system 100, and each UE may be stationary or mobile. A UE also may be referred to as an access terminal, a terminal, a mobile station, a subscriber unit, or a station, among other examples. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, among other examples, which may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices or may be implemented as NB-IoT (narrowband internet of things) devices. Some UEs may be considered a Customer Premises Equipment (CPE). UE 120 may be included inside a housing that houses components of UE 120, such as processor components, memory components, similar components, or a combination thereof.

In general, any number of RANs may be deployed in a given geographic area. Each RAN may support a particular RAT and may operate on one or more frequencies. A RAT also may be referred to as a radio technology, an air interface, among other examples. A frequency also may be referred to as a carrier, a frequency channel, among other examples. Each frequency may support a single RAT in a given geographic area in order to avoid interference between RANs of different RATs. In some cases, NR or 5G RANs may be deployed.

In some examples, access to the air interface may be scheduled, where a scheduling entity (for example, a base station) allocates resources for communication among some or all devices and equipment within the scheduling entity's service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity.

Base stations are not the only entities that may function as a scheduling entity. That is, in some examples, a UE may function as a scheduling entity, scheduling resources for one or more subordinate entities (for example, one or more other UEs). In this example, the UE is functioning as a scheduling entity, and other UEs utilize resources scheduled by the UE for wireless communication. A UE may function as a scheduling entity in a peer-to-peer (P2P) network, in a mesh network, or another type of network. In a mesh network example, UEs may optionally communicate directly with one another in addition to communicating with the scheduling entity.

Thus, in a RAN with a scheduled access to time-frequency resources and having a cellular configuration, a P2P configuration, and a mesh configuration, a scheduling entity and one or more subordinate entities may communicate utilizing the scheduled resources.

In some aspects, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the UE 120 may perform scheduling operations, resource selection operations, as well as other operations described elsewhere herein as being performed by the base station 110.

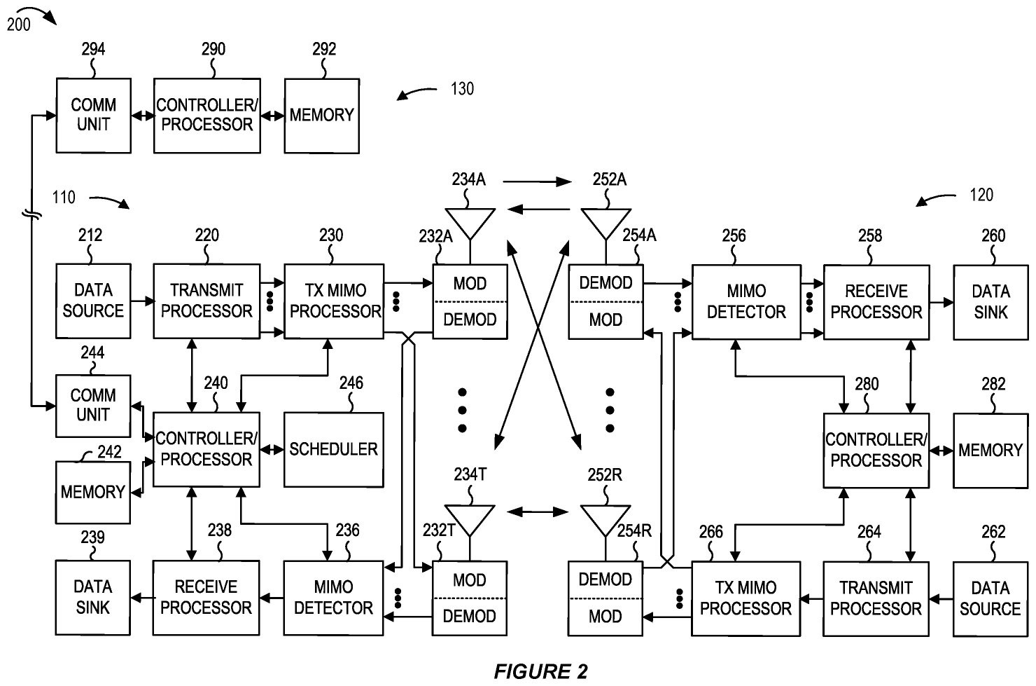

FIG. 2 is a block diagram conceptually illustrating an example 200 of a base station 110 in communication with a UE 120. In some aspects, the base station 110 and the UE 120 may respectively be one of the base stations and one of the UEs in wireless communication system 100 of FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (for example, encode and modulate) the data for each UE based at least in part on the MCS(s) selected for the UE, and provide data symbols for all UEs. The transmit processor 220 also may process system information (for example, for semi-static resource partitioning information (SRPI) or the like) and control information (for example, CQI requests, grants, upper layer signaling, among other examples.) and provide overhead symbols and control symbols. The transmit processor 220 also may generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide T output symbol streams to T modulators (MODs) 232a through 232t. Each modulator 232 may process a respective output symbol stream (for example, for OFDM) to obtain an output sample stream. Each modulator 232 may further process (for example, convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 or other base stations and may provide received signals to demodulators (DEMODs) 254a through 254r, respectively. Each demodulator 254 may condition (for example, filter, amplify, downconvert, and digitize) a received signal to obtain input samples. Each demodulator 254 may further process the input samples (for example, for OFDM) to obtain received symbols. A MIMO detector 256 may obtain received symbols from all R demodulators 254a through 254r, perform MIMO detection on the received symbols if applicable, and provide detected symbols. A receive processor 258 may process (for example, demodulate and decode) the detected symbols, provide decoded data for UE 120 to a data sink 260, and provide decoded control information and system information to a controller or processor (controller/processor) 280. A channel processor may determine RSRP, RSSI, RSRQ, channel quality indicator (CQI), among other examples. In some aspects, one or more components of UE 120 may be included in a housing.

On the uplink, at UE 120, a transmit processor 264 may receive and process data from a data source 262 and control information (for example, for reports including RSRP, RSSI, RSRQ, CQI, among other examples) from controller/processor 280. Transmit processor 264 also may generate reference symbols for one or more reference signals. The symbols from transmit processor 264 may be precoded by a TX MIMO processor 266 if applicable, further processed by modulators 254a through 254r (for example, for DFT-s-OFDM, CP-OFDM, among other examples), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to a controller or processor (i.e., controller/processor) 240. The base station 110 may include a communication unit 244 and may communicate to the network controller 130 via the communication unit 244. The network controller 130 may include a communication unit 294, a controller or processor (i.e., controller/processor) 290, and memory 292.

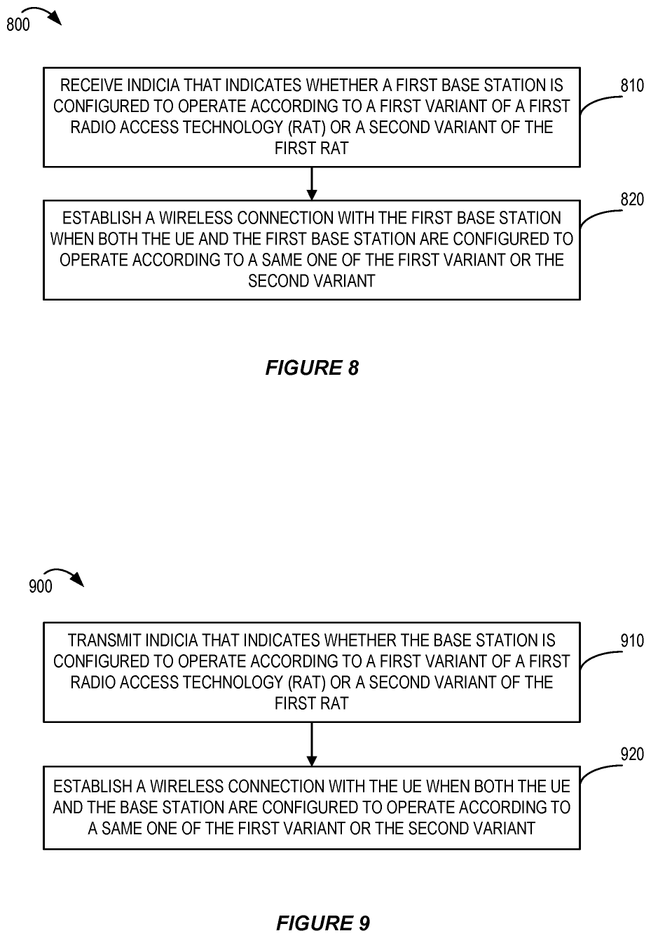

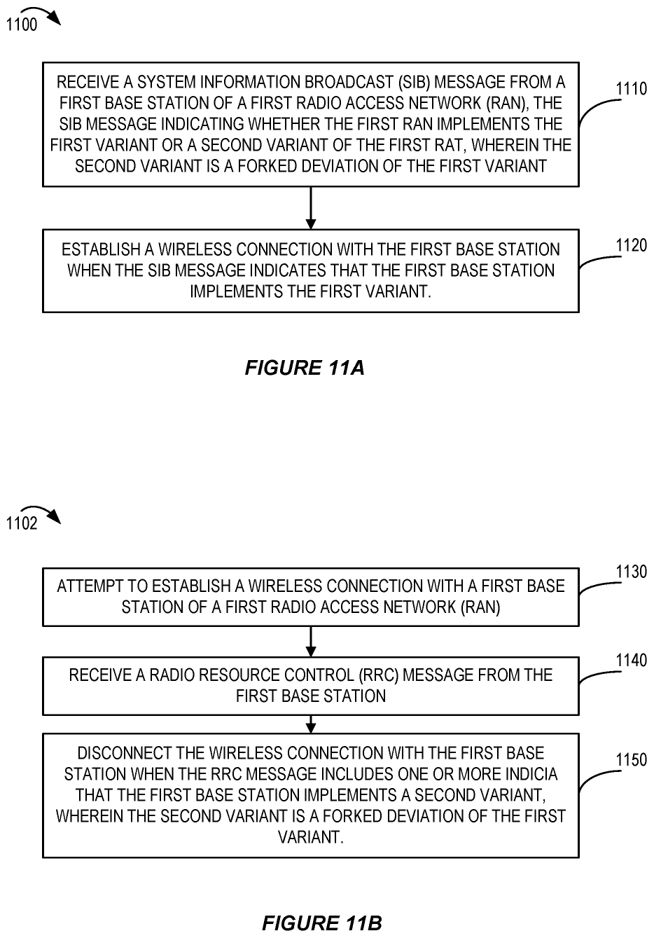

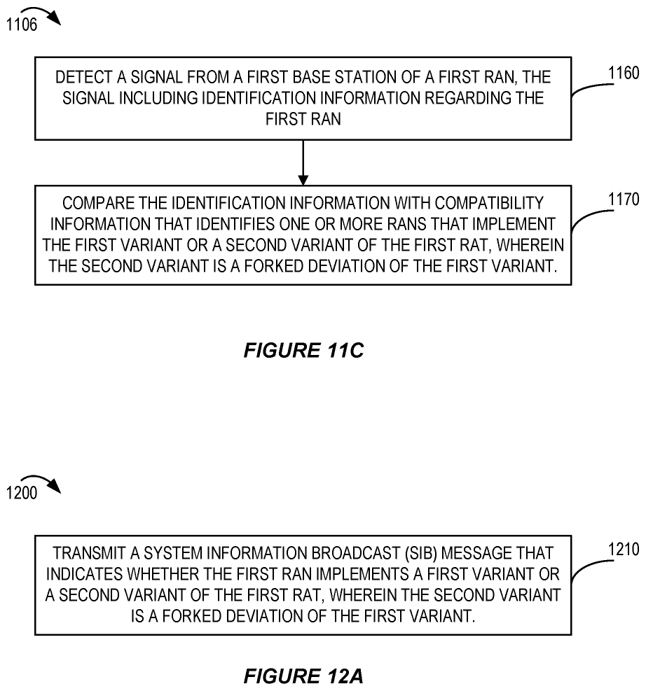

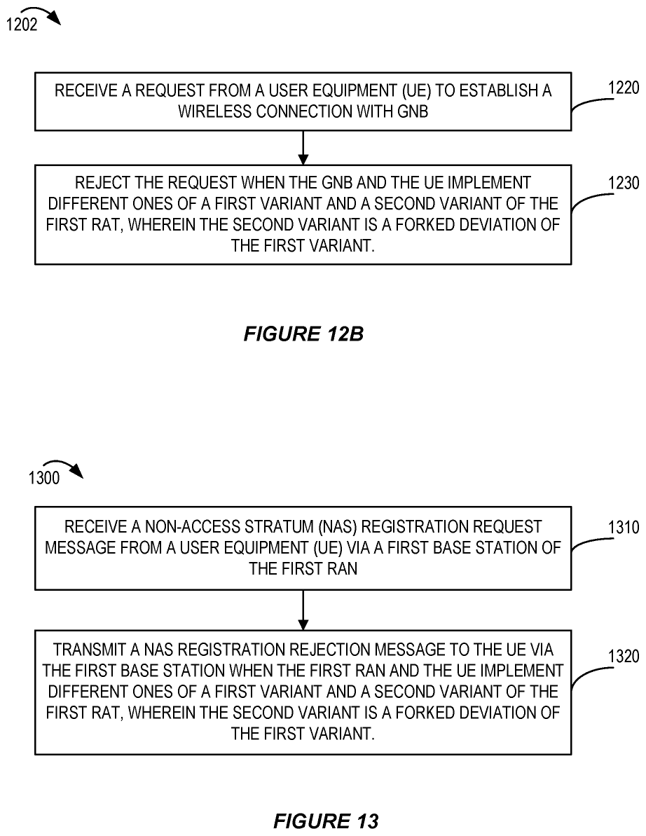

The controller/processor 240 of base station 110, the controller/processor 280 of UE 120, or any other component(s) of FIG. 2 may implement an RRC protocol between the base station 110 and the UE 120. The controller/processor 240 may manage the BS 110 in accordance with implementations described in more detail elsewhere herein. For example, the controller/processor 240 of BS 110, or any other component(s) (or combinations of components) of FIG. 2 may perform or direct operations of, for example, processes 900, 1200, or 1202 of FIGS. 9, 12A or 12B, respectively, or other processes as described herein. The controller/processor 280 may manage the UE 120 in accordance with implementations described in more detail elsewhere herein. For example, the controller/processor 280 of UE 120, or any other component(s) (or combinations of components) of FIG. 2 may perform or direct operations of, for example, processes 800, 1100, 1102, or 1106 of FIGS. 8, 11A, 11B or 11C, respectively, or other processes as described herein. The memories 242 and 282 may store data and program codes for base station 110 and UE 120, respectively. The stored program codes, when executed by the controller/processor 280 or other processors and modules at UE 120, may cause the UE 120 to perform operations described with respect to processes 800, 1100, 1102, or 1106 of FIGS. 8, 11A, 11B or 11C, respectively, or other processes as described herein. The stored program codes, when executed by the controller/processor 240 or other processors and modules at BS 110, may cause the BS 110 to perform operations described with respect to processes 900, 1200 or 1202 of FIGS. 9, 12A or 12B, respectively, or other processes as described herein. A scheduler 246 may schedule UEs for data transmission on the downlink, the uplink, or a combination thereof.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, the TX MIMO processor 266, or another processor may be performed by or under the control of controller/processor 280.

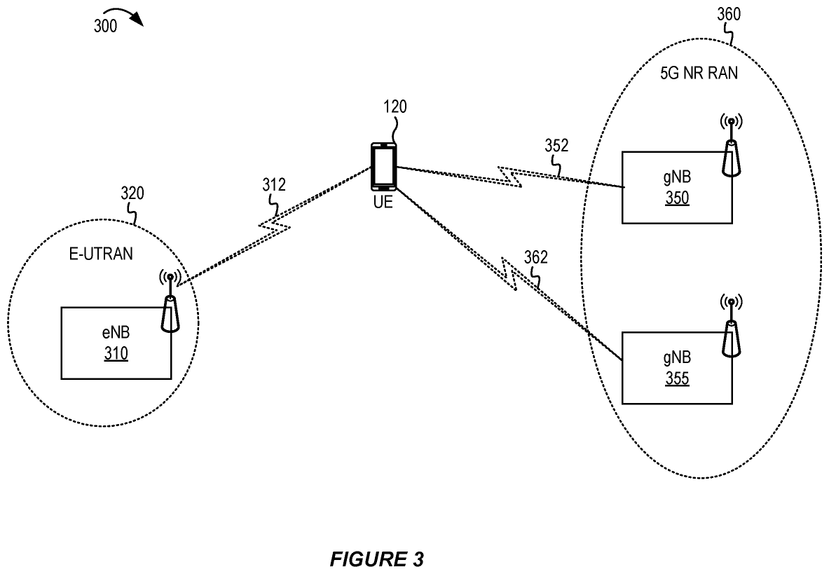

FIG. 3 shows a block diagram conceptually illustrating a wireless communication system 300 in which an example UE may perform a cell selection procedure based on a RAT. The example wireless communication system 300 includes a UE 120 and two example RATs for an access stratum of the wireless communication system 300. An LTE RAN 320 may include one or more base stations (such as eNB 310) that implement a 4G LTE RAT. The LTE RAN 320 also may be referred to as an evolved universal terrestrial radio access network (E-UTRAN). A 5G NR RAN 360 may include one or more base stations (such as gNBs 350 and 355) that implement a 5G NR RAT. For example, the base stations may implement the 5G NR RAT by formatting and communicating messages in accordance with a variant of a standard specification, receive and process messages from the UE in accordance with the variant, and support communication features or protocols defined for the variant. Each base station may operate multiple cells. The LTE RAN 320 and the 5G NR RAN 360 are examples of different types of RANs that implement different RATs. In some implementations, both of the RANs may use the same core network and may be part of the same PLMN of a wireless communication network operator. A PLMN is the area of land covered by a wireless communication network operator for voice and data services to a mobile subscriber.

The UE 120 may include components (not shown), such a wireless communication module and a connection controller, among other examples. In some implementations, a single chip or component of the UE 120 may provide the wireless communication module and the connection controller and may communicate via one or more radio components of the UE 120. The wireless communication module may be capable of establishing a wireless connection with an eNB 310 of the LTE RAN 320 or with a gNB (such as gNB 350 or gNB 355) of the 5G NR RAN 360. For brevity, the description refers to the UE 120 making these connections. The UE 120 may refer to a portable electronic device or to one or more components of the portable electronic device.

When the UE 120 first powers up, the UE 120 perform an initial cell selection procedure in which the UE searches for a suitable cell of a base station to access the wireless communication network, register its presence using a NAS registration procedure in the tracking area of the chosen cell, and monitors a control channel of the chosen cell. This procedure may be referred to as “camping on the cell.” In some implementations, the UE 120 may receive a broadcast system information message from one or more of base stations within communication range of the UE 120. The broadcast system information message may include frequency information indicating available frequencies of various cells of the base stations. Typically, the UE 120 may select a base station that provides a higher signal quality or throughput. For example, the UE 120 may perform measurements of the 312, 352 and 362 signals received from the eNB 310, gNB 350 and gNB 355, respectively. Traditionally, the UE 120 may select one of the base stations having a higher signal quality and initiate a wireless connection to the selected base station. In some implementations, the UE 120 may use an RRC protocol to initiate a wireless connection with the selected base station. For example, the UE 120 may send an RRC connection request to the selected base station. The RRC protocol may include a variety of messages that a base station can send to the UE 120 during a connection setup phase, such as an RRC connection establishment message, an RRC connection rejection message, an RRC redirection message, an RRC configuration message, or the like.

For the purpose of highlighting how a standards variant can impact service for a UE 120, consider a scenario in FIG. 3 in which the UE 120 implements a first variant of the 5G NR RAT and the 5G NR RAN 360 implements a second variant of the 5G NR RAT. For example, the UE 120 may be a 3GPP UE and the 5G NR RAN 360 may implement non-3GPP gNBs 350 and 355. The second variant may be a forked deviation of the first variant such that the 5G NR RAT is partially the same but also includes some differences that could cause compatibility issues. Absent the techniques of this disclosure, the UE 120 may initiate a wireless connection with the gNB 350 based on signal strength. However, the wireless connection may fail or stall due to the incompatibility of the second variant. For example, the gNB 350 and the UE 120 may fail to properly establish an RRC connection. In some instances, the failure may not be immediately discovered, causing delay before the gNB 350 or the UE 120 determines that the RRC connection is not working. The UE 120 may then perform a cell reselection and initiate a wireless connection with the gNB 355. When that wireless connection fails due to the same incompatibility, the UE 120 may initiate a wireless connection with the eNB 310. Meanwhile, each failed attempt or improperly established RRC connection may cause delay, decrease performance of the network, diminish user satisfaction, or any combination thereof.

In some aspects of this disclosure, the UE 120 may determine that the 5G NR RAN 360 is configured to operate according to an incompatible variant of the 5G NR RAT more quickly and may prevent the delay that would otherwise occur due to the incompatibility. For example, the UE 120 may obtain a broadcast system information message from the gNB 350 that indicates that the gNB 350 is configured to operate according to a particular variant of the 5G NR RAT. If the UE 120 is configured to operate according to that variant, the UE 120 may attempt to connect with the gNB 350. However, if the UE 120 is not configured to operate according to that variant, the UE 120 may prevent the gNB 350 from being selected during a network selection/reselection procedure. Furthermore, in some implementations, the UE 120 also may prevent the gNB 355 belonging to the same 5G NR RAN 360 as the gNB 350 from being selected during the network selection/reselection.

In some implementations, the UE 120 may determine that it is located in a geographic territory that mandates the incompatible variant of the 5G NR RAT and may refrain from initiating a 5G wireless connection while the UE 120 is located in that geographic territory. For example, a regional standards development organization may adopt a second variant of 5G NR RAT that is incompatible with a first variant of 5G NR RAT. The UE 120 may refrain from using the 5G NR RAT when the UE 120 is roaming in a territory governed by that regional standards development organization. Instead, the UE 120 may prioritize base stations that utilize a compatible variant of the LTE RAT.

This disclosure includes a variety of techniques by which the UE 120 may determine that it is located in a geographic territory associated with the incompatible variant of the 5G NR RAT. For example, the UE 120 may detect the incompatible RAT based on location data (such as a satellite-based location determination system), a system information broadcast message, an RRC protocol error, a NAS registration rejection message, a preconfigured list of PLMNs or MCCs, or any combination thereof. In one aspect, the UE 120 may receive or store a list of incompatible MCCs that are associated with a particular geographic territory known to implement an incompatible variant of the 5G NR RAT. For example, the list of incompatible MCCs may include those MCCs (such as, MCCs 404-406) that are associated with a particular country (such as, India). Although described herein as a list of incompatible MCCs, it is possible for the list to include one or more than one entry. Furthermore, the techniques of this disclosure may be modified such that the list of MCCs are for those that are compatible rather than a list of incompatible MCCs. For brevity, the list described herein may identify incompatible MCCs. The list of incompatible MCCs may be received via the 5G NR RAN 360 as part of an access stratum (AS) rejection message or a NAS registration rejection message. Alternatively, or additionally, the list of incompatible MCCs may be stored in a memory of the UE 120 (such as a SIM card or the like) by a home PLMN of the UE 120 outside the particular geographic territory. When the UE 120 observes a broadcast system information message from a base station (such as the gNB 350) that includes an MCC on the list of incompatible MCCs, the UE 120 may prevent the 5G NR RAT from being used with any base station of the 5G NR RAN 360. In another aspect, the UE 120 may detect an RRC protocol error that indicates the gNB 350 and the UE 120 are configured to operate according to different variants of the 5G NR RAT. For example, an RRC configuration message from the gNB 350 may include a configuration setting for a feature that is adopted in the non-3GPP variant (but not the 3GPP variant) of the 5G NR RAT such that the UE 120 can determine that the 5G NR RAN 360 is configured to operate according to an incompatible variant of the 5G NR RAT.

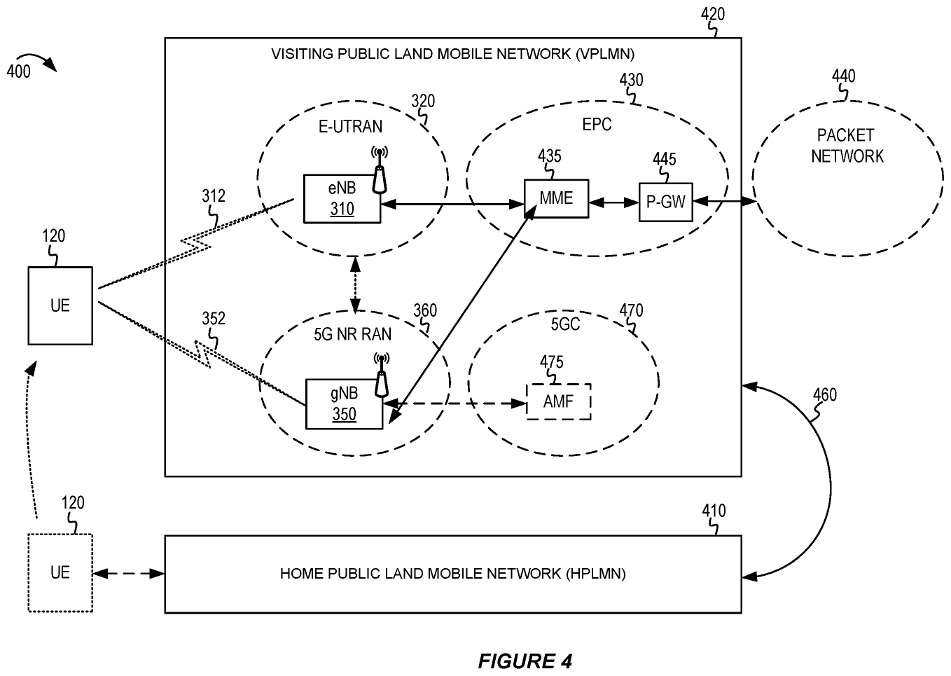

FIG. 4 shows a block diagram conceptually illustrating an example wireless communication system 400 in which a UE may roam to an area of a PLMN that is configured to operate according to an incompatible variant of a first RAT. A UE 120 may be a subscriber of a first PLMN, referred to as the HPLMN 410. A PLMN identifier (PLMN ID) may be based on a combination of a Mobile Country Code (MCC) and a Mobile network code (MNC). Each UE may have a SIM card or other memory that stores an international mobile subscriber identity (IMSI) that is linked to a particular PLMN. While roaming, a subscriber changes its location, and may enter a coverage area associated with a different PLMN which is referred to as a VPLMN 420 with respect to the UE. The VPLMN 420 may operate different RANs, such as LTE RAN 320 and a 5G NR RAN 360, among other examples. Each PLMN also may operate a different core network. In the example of FIG. 4, the VPLMN 420 operates an evolved packet core (EPC) 430 and a packet network 440.

The EPC 430 is just one example of a core network that may be used in a non-access stratum of a wireless communication system. In some implementations, the 5G NR RAN 360 may use the same EPC 430 as the LTE RAN 320. Alternatively, the 5G NR RAN 360 may use a 5G Core (5GC) 470 with a 5G Core Access and Mobility Management Function (AMF) 475 that performs similar functionality as the Mobility Management Entity (MME) 435 of the EPC 430. The 5GC 470 may connect to the packet network 440. In some deployments, the same packet network 440 may provide access to services such as Internet access, an Internet protocol (IP) multimedia subsystem (IMS) service, or other services.

In the example of FIG. 4, a UE 120 that is associated with the HPLMN 410 travels outside the geographic area of the HPLMN 410. The UE 120 may obtain roaming connectivity via the VPLMN 420. The HPLMN 410 and the VPLMN 420 may have a roaming agreement or policy so that the VPLMN 420 can provide service to the UE 120. Typically, the VPLMN 420 would communicate with a node of the HPLMN 410 (such as a home location register (HLR)) to update the location and roaming status of the subscriber. For brevity, the communication between VPLMN 420 and the HPLMN 410 is shown at arrow 460.

In one aspect, a VPLMN 420 may determine that the roaming UE 120 is from a HPLMN 410 that is configured to operate according to a first variant of the 5G NR RAT while its own 5G NR RAN 360 is configured to operate according to a second variant of the 5G NR RAT. For example, during a location update with the HPLMN 410, the VPLMN 420 may determine that the roaming UE 120 is from an area that has adopted a first variant. In some implementations, the VPLMN 420 may send a NAS registration rejection message to the UE 120. Alternatively, or additionally, the VPLMN 420 may cause the 5G NR RAN 360 to reject an RRC connection request by sending a RRC reject message to the roaming UE 120. In some implementations, the NAS registration rejection message or the RRC reject message (or both) may include a cause code that indicates that the 5G NR RAN 360 is configured to operate according to an incompatible variant of the 5G NR RAT. Thus, the UE 120 can prevent further connection attempts with other gNBs (not shown) of the 5G NR RAN 360. Alternatively, or additionally, the gNB 350 may reject the RRC connection request by sending an RRC redirection message. The RRC redirection message may instruct the roaming UE 120 to establish the RRC connection with the eNB 310 of the LTE RAN 320 instead of the gNB 350 of the 5G NR RAN 360. In some implementations, the NAS registration rejection message or the RRC reject message (or both) may include an indication of one or more incompatible MCCs to prevent the UE 120 from selecting the 5G NR RAT for the VPLMN 420 (or other VPLMNs, not shown) associated with the one or more incompatible MCCs. In some implementations, the NAS registration rejection message or the RRC reject message (or both) may indicate a condition such as expiration of a time duration, a power cycle, a SIM change, a change in location, detecting a different MCC, or other condition before the UE 120 will attempt a connection using the 5G NR RAT.

In another aspect, the HPLMN 410 may configure the UE 120 with one or more MCCs or PLMN IDs (such as a list of incompatible MCCs) of one or more VPLMNs that are configured to operate according to an incompatible variant of the 5G NR RAT. For example, the HPLMN 410 may provision a memory of a SIM card (not shown) in the UE 120 with a list of incompatible MCCs. When the HPLMN 410 roams to an area of the VPLMN 420, the UE 120 may receive a broadcast system information message from the gNB 350 or the eNB 310 that identifies the VPLMN 420 based on a PLMN ID or MCC. If the PLMN ID or MCC is in the list of incompatible MCCs, the UE 120 may determine that the VPLMN 420 is configured to operate according to an incompatible variant of the 5G NR RAT. The UE 120 may refrain from connecting to a gNB 350 of the 5G NR RAN 360 and instead select the eNB 310 of the LTE RAN 320.

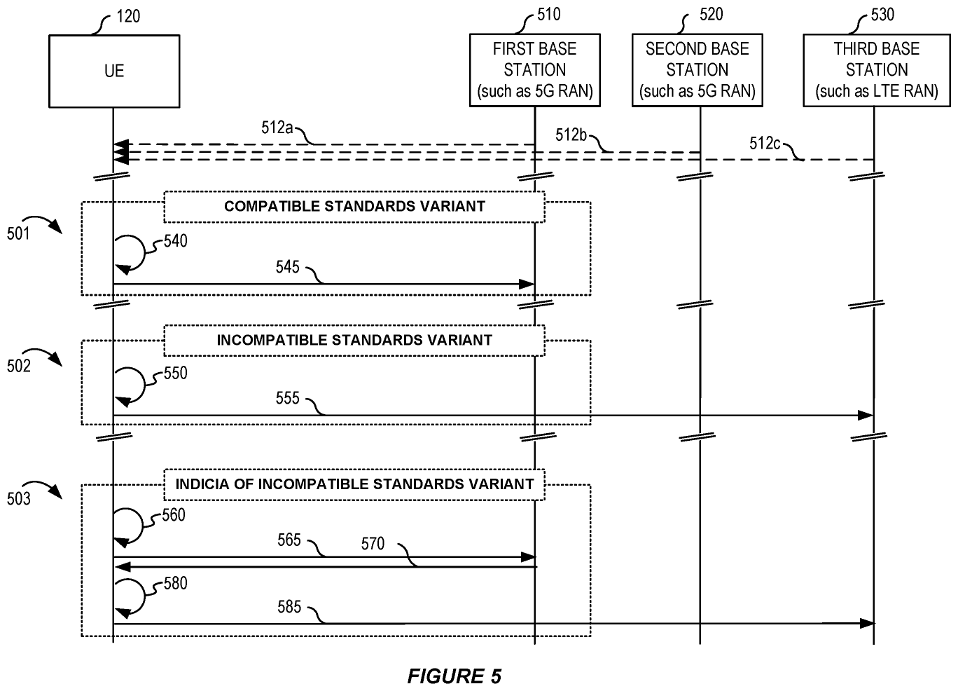

FIG. 5 shows a message flow diagram conceptually illustrating examples of how a UE may perform cell selection based on a standards variant implemented at a base station. A UE 120 may receive broadcast system information from several base stations in vicinity of the UE 120. For example, the UE 120 in FIG. 5 may receive broadcast system information messages 512a, 512b, and 512c a first base station 510, a second base station 520 and a third base station 530, respectively. As an example, the first base station 510 may be a gNB associated with a 5G NR RAT. As will be described in the examples 501, 502, and 503, the UE 120 may determine whether the first base station 510 is configured to operate according to a variant of the 5G NR RAT that is compatible with the variant implemented by the UE 120.

In a first example 501, the broadcast system information message 512a from the first base station 510 may include a field that indicates whether the first base station 510 is configured to operate according to a particular variant of the 5G NR RAT. For example, an information element (IE) or field of a SIB message may indicate whether the first base station 510 is configured to operate according to a 3GPP variant or a non-3GPP variant of the 5G NR RAT. Alternatively, or additionally, the broadcast system information message 512a may include a PLMN ID or MCC that is related to a geographic area known to implement a compatible variant of the 5G NR RAT. Thus, either based on an explicit SIB field or other indicia in the broadcast system information message 512a, the UE 120 may determine (shown at block 540) that the first base station 510 and the UE 120 are configured to operate according to compatible variants of the 5G NR RAT in the first example 501. For example, they may both be configured to operate according to a 3GPP variant, or they may both be configured to operate according to the same non-3GPP variant. In another example, the variants implemented by the UE 120 and the first base station 510 may be different but may be deemed compatible based on conformance testing during adoption of the one or both of the variants. Because the first base station 510 and the UE 120 are configured to operate according to compatible variants of the 5G NR RAT, the UE 120 may establish a 5G wireless connection with the first base station 510. For example, the UE 120 may send an RRC connection request message 545 that results in a successful RRC connection.

In a second example, 502, the broadcast system information message 512a from the first base station 510 may indicate that the first base station 510 is configured to operate according to an incompatible variant of the 5G NR RAT. Alternatively, or additionally, the broadcast system information message 512a may include a PLMN ID or MCC that is related to a geographic area known to implement an incompatible variant of the 5G NR RAT. Thus, either based on an explicit SIB field or other indicia in the broadcast system information message 512a, the UE 120 may determine (shown at block 550) that the first base station 510 and the UE 120 are configured to operate according to different variants of the 5G NR RAT that are incompatible with one another in the second example 502. For example, the UE 120 may be configured to operate according to a 3GPP variant or and the first base station 510 may be configured to operate according to a non-3GPP variant. The different variants may be deemed incompatible based on conformance testing during adoption of the one or both of the variants. Because the first base station 510 and the UE 120 are configured to operate according to incompatible variants of the 5G NR RAT, the UE 120 may refrain from establishing a 5G wireless connection with the first base station 510. For example, the UE 120 may disregard the first base station 510 when performing a cell selection or reselection procedure. In some implementations, the UE 120 may discontinue performing cell reselection measurements regarding the first base station 510 since the UE 120 will not select the first base station 510 during a cell reselection. In some implementations, the UE 120 also may disregard signals and prevent a 5G connection to the second base station 520 if the second base station 520 belongs to the same 5G NR RAN as the first base station 510. Thus, in the second example 502, the UE 120 may establish a wireless connection with a 4G eNB such as the third base station 530. The UE 120 may send an RRC connection request message 555 to the third base station 530 that results in a successful RRC connection.

In a third example 503, the broadcast system information message 512a from the first base station 510 may not indicate which variant of the 5G NR RAT is being used by the first base station 510. For example, the system information message 512a may omit or otherwise not include a field to indicate which variant the first base station 510 is using for communication with the UE 120. The UE 120 may attempt to process the system information message 512a and determine (shown at block 560) that it cannot determine which variant of the 5G NR RAT that the first base station 510 is configured to use for further communication. In such a scenario, the UE 120 may still determine whether the first base station 510 supports a compatible variant of the 5G NR RAT based on contents of an RRC protocol message. For example, the UE 120 may send an RRC connection request message 565 to the first base station 510 and may receive an RRC configuration message 570 from the first base station 510. The UE 120 may inspect the contents of the RRC configuration message 570 for indicia regarding the variant of the 5G NR RAT that the first base station 510 is configured to use for communication in the RAN. For example, the RRC configuration message 570 may include a configuration setting or parameter associated with a feature defined in the second variant that is not defined in the first variant. For example, the RRC configuration message 570 may include an information element for a modulation scheme setting, phase transform precoding setting, or another feature that is unique to the second variant of the 5G NR RAT. The UE 120 may determine (shown at block 580) that the first base station 510 and the UE 120 are configured to operate according to incompatible variants of the 5G NR RAN based on the contents of the RRC configuration message 570. In some implementations, the UE 120 may include, in the RRC connection request message 565, an indication related to an incompatible capability parameter related to the second variant even though the UE 120 does not support the second variant. By including the incompatible capability parameter in the RRC connection request message 565, the UE 120 can test the first base station 510 to determine whether the first base station 510 is configured to operate according to the second variant. If the first base station 510 responds with the RRC configuration message 570 including an information element related to the incompatible capability parameter, the UE 120 may assume that the first base station 510 is configured to operate according to the incompatible second variant of the 5G NR RAT. Thus, the UE 120 may discover that the first base station 510 is configured to operate according to the second variant either by receiving an unsolicited configuration setting or parameter associated with a feature defined in the second variant that is not defined in the first variant or by challenging the first base station 510 to send the configuration setting or parameter.

Because the first base station 510 and the UE 120 are configured to operate according to incompatible variants of the 5G NR RAT, the UE 120 may refrain from establishing a 5G wireless connection with the first base station 510. For example, the UE 120 may disregard the first base station 510 when performing a cell selection or reselection procedure. In some implementations, the UE 120 may discontinue performing cell reselection measurements regarding the first base station 510 since the UE 120 will not select the first base station 510 during a cell reselection. In some implementations, the UE 120 also may disregard signals and prevent a 5G connection to the second base station 520 if the second base station 520 belongs to the same 5G NR RAN as the first base station 510. Thus, in the third example 503, the UE 120 may establish a wireless connection with a 4G eNB such as the third base station 530. The UE 120 may send an RRC connection request message 585 to the third base station 530 that results in a successful RRC connection.

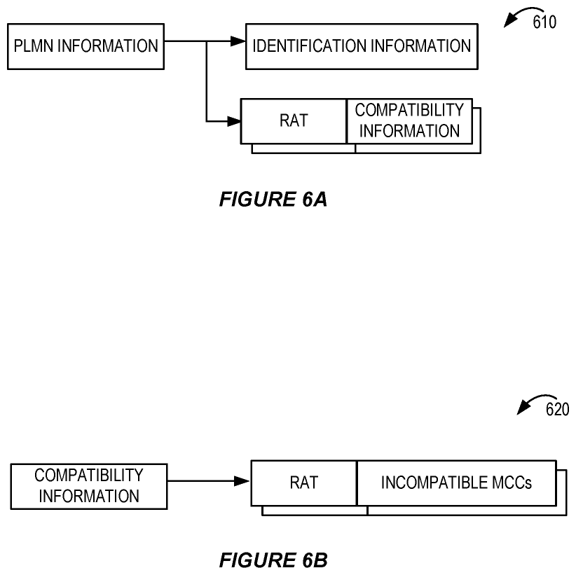

FIG. 6A shows an example data structure 610 for storing compatibility information regarding a public land mobile network (PLMN). The example data structure 610 includes PLMN information for one or more PLMNs. The PLMN information may include identification information (such as a PLMN ID, an MCC, an MNC, or any combination thereof). In relation to the PLMN, the example data structure 610 may include compatibility information for one or more RATs. For example, the compatibility information may indicate which variant of 5G NR RAT is implemented by the base stations in that PLMN.

FIG. 6B shows an example data structure 620 for storing compatibility information based on mobile country codes (MCCs). The example data structure 620 may include a list of incompatible MCCs associated with a particular RAT. For example, a 3GPP UE may store compatibility information that includes a list of incompatible MCCs associated with a geographic territory that is associated with a non-3GPP variant of the 5G NR RAT. When the 3GPP UE roams to a geographic area and detects a message from a base station indicating a MCC on the list of incompatible MCCs, the 3GPP UE may determine that the RAN associated with that base station is configured to operate according to an incompatible variant of the RAT.

The example data structures in FIGS. 6A and 6B are provided as illustrative examples. The information described with reference to FIGS. 6A and 6B may be stored in a variety of different forms and formats (such as a database, a text file, or a location in memory, among other examples). In some implementations, the information described with reference to FIGS. 6A and 6B may be stored in a SIM card or other memory of a UE.

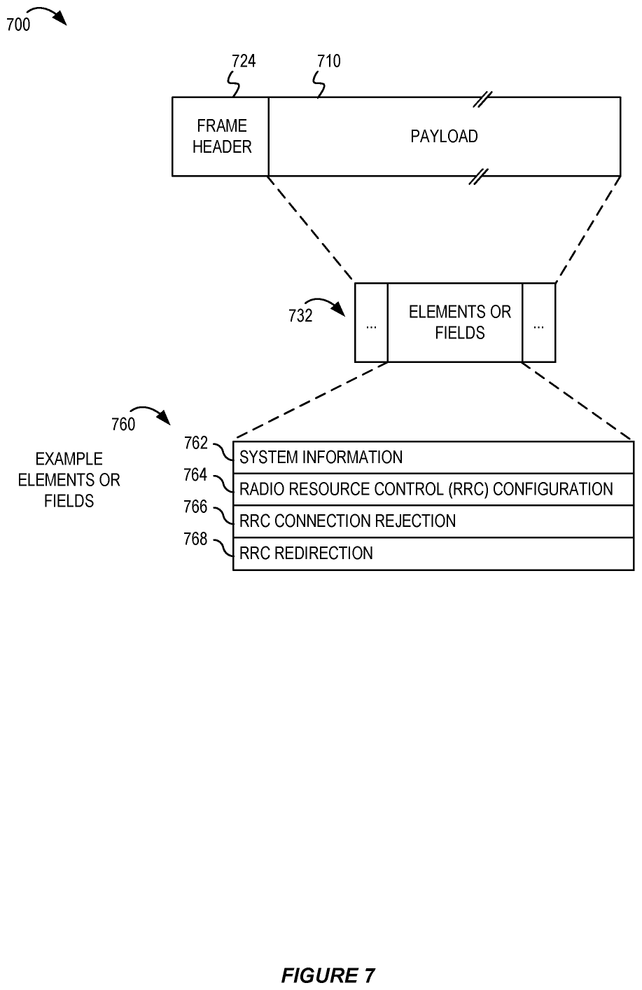

FIG. 7 shows a conceptual diagram of an example message that may be used to share or discover which standards variant of a RAT is implemented by a radio access network (RAN). The message 700 may include a frame header 724 and a payload 710. The frame header 724 may indicate the type of message or other frame control information. The payload 710 may include a variety of elements or fields 732. The elements or fields also may be referred to as information elements in some message formats. FIG. 7 includes several example elements or fields 760 that may be sent from a base station to a UE depending on a type of the message 700.

In some implementations, the example elements or fields 760 may include system information 762. For example, the system information 762 may be formatted as SIB. In some implementations, the example elements or fields 760 may include an RRC configuration 764, an RRC connection rejection 766, or an RRC redirection 768. The RRC configuration 764, the RRC connection rejection 766, and the RRC redirection 768 may be part of an RRC protocol that has been modified such that the message 700 includes indicia that indicates a base station is configured to operate according to a particular variant of a RAT. In some implementations, the RRC connection rejection 766 or the RRC redirection 768 may include a cause code that indicates the reason for the rejection or redirection is based on an incompatible variant of the RAT.

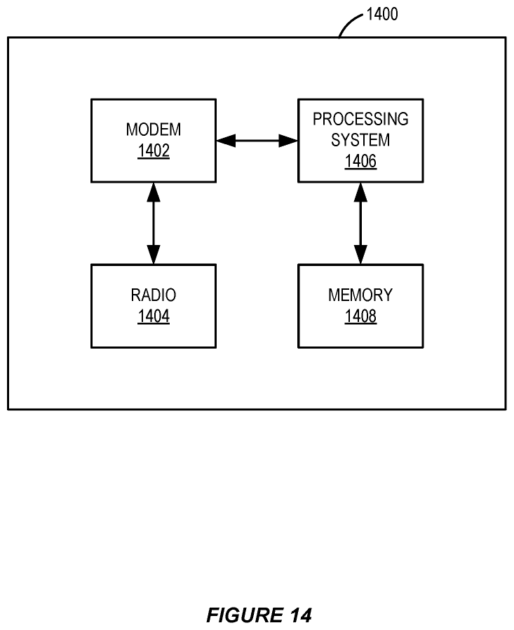

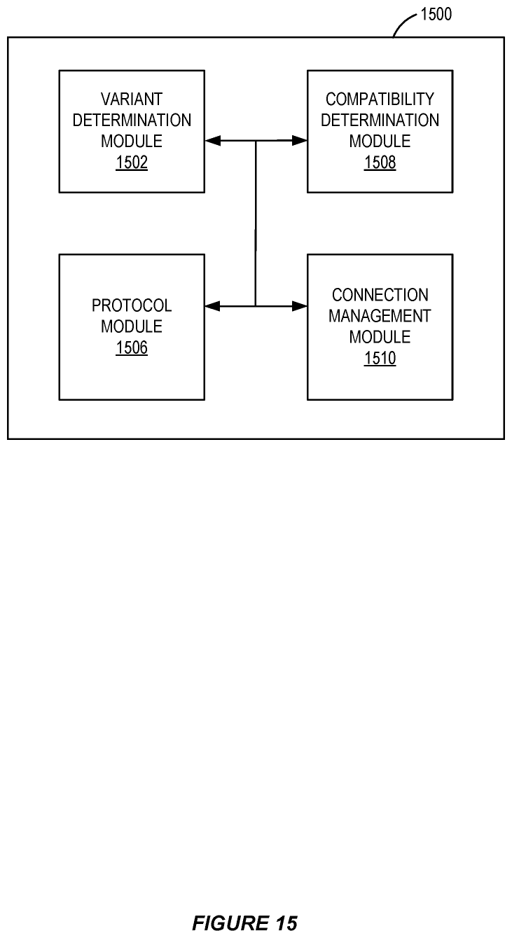

FIG. 8 shows a flowchart illustrating an example process for wireless communication by a UE based on a variant of a RAT implemented by a base station. The operations of the process 800 may be implemented by a wireless communication device, a UE, or any component thereof as described herein. In some implementations, the process 800 (or portions thereof) may be performed by a UE, such as one of the examples UEs 120 described herein. In some implementations, the process 800 may be performed by a wireless communication device, such as the wireless communication device 1400 or 1500 described with reference to FIGS. 14 and 15, respectively. For brevity, the example process 800 is described as being performed by an apparatus that could be any of the above indicated UEs, wireless communication device, or a component thereof.

In block 810, the apparatus may receive indicia that indicates whether a first base station is configured to operate according to a first variant of a first radio access technology (RAT) or a second variant of the first RAT.

In block 820, the apparatus may establish a wireless connection with the first base station when both the UE and the first base station are configured to operate according to a same one of the first variant or the second variant.

FIG. 9 shows a flowchart illustrating an example process for wireless communication by a base station based on a variant of a RAT implemented by the base station. The operations of the process 900 may be implemented by a wireless communication device, a base station, or any component thereof as described herein. In some implementations, the process 900 (or portions thereof) may be performed by a base station, such as any one of the example base stations 110, 310, 350, 360, 510, 520, or 530 described herein. In some implementations, the process 900 may be performed by a wireless communication device, such as the wireless communication device 1400 or 1500 described with reference to FIGS. 14 and 15, respectively. For brevity, the example process 900 is described as being performed by an apparatus that could be any of the above indicated base stations, wireless communication device, or a component thereof.

In block 910, the apparatus may transmit indicia that indicates whether the base station is configured to operate according to a first variant of a first radio access technology (RAT) or a second variant of the first RAT.

In block 920, the apparatus may establish a wireless connection with the UE when both the UE and the base station are configured to operate according to a same one of the first variant or the second variant.

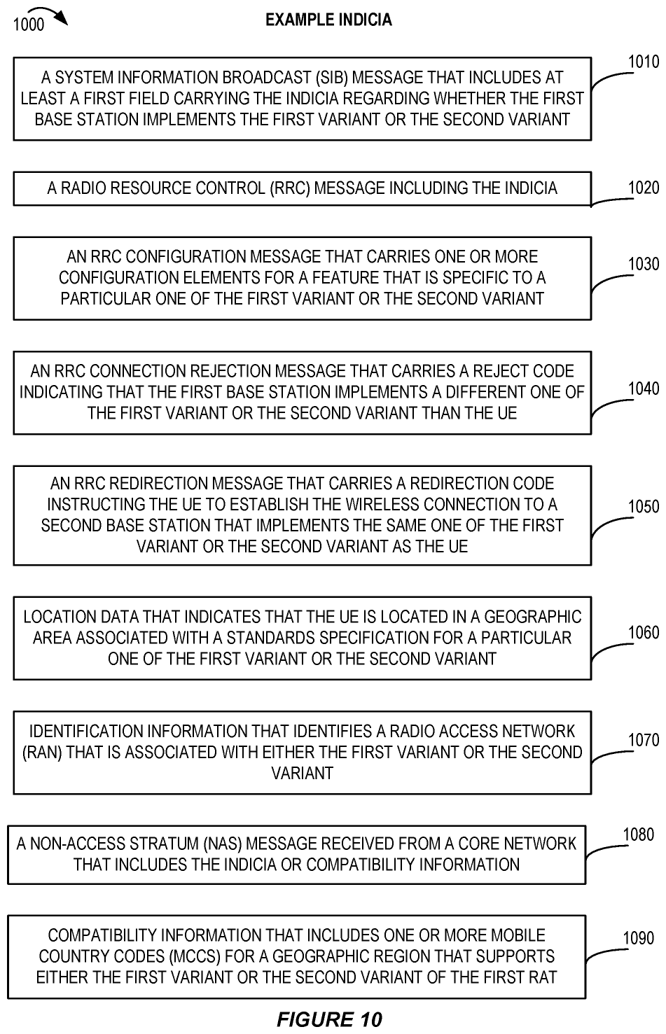

FIG. 10 shows example indicia 1000 that can indicate a variant of a RAT implemented by the base station. Any combination of the example indicia may be used by a UE to determine which variant of the first RAT is implemented by a base station.

In a first example, the indicia 1010 may be obtained from a system information broadcast (SIB) message that includes at least a first field carrying the indicia regarding whether the base station implements the first variant or the second variant.

In a second example, the indicia 1020 may be obtained from a radio resource control (RRC) message including the indicia.

In a third example, the indicia 1030 may be based on a determination that an RRC configuration message carries one or more configuration elements for a feature that is specific to a particular one of the first variant or the second variant.

In a fourth example, the indicia 1040 may be obtained from an RRC connection rejection message that carries a reject code indicating that the base station implements a different one of the first variant or the second variant than the UE.

In a firth example, the indicia 1050 may be obtained from an RRC redirection message that carries a redirection code instructing the UE to establish the wireless connection to a second base station that implements the same one of the first variant or the second variant as the UE.

In a sixth example, the indicia 1060 may be obtained from location data that indicates that the UE is located in a geographic area associated with a standards specification for a particular one of the first variant or the second variant. For example, a UE may receive location data that indicates the UE is located in a geographic area. The UE may retrieve the indicia from compatibility information that correlates the geographic area in association with a standards specification for a particular one of the first variant or the second variant.

In a seventh example, the indicia 1070 may be based on identification information received from the base station that identifies a radio access network (RAN) that is associated with either the first variant or the second variant.

In an eighth example, the indicia 1080 may be obtained from a non-access stratum (NAS) message received from a core network that includes the indicia or compatibility information.

In a ninth example, the indicia 1090 may be based on compatibility information that includes one or more mobile country codes (MCCs) for a geographic region that supports either the first variant or the second variant of the first RAT.

FIG. 11A shows a flowchart illustrating an example process 1100 in which a UE determines a variant of a RAT implemented by a base station based on a system information broadcast (SIB) message. The operations of the process 1100 may be implemented by a wireless communication device, a UE, or any component thereof as described herein. In some implementations, the process 1100 (or portions thereof) may be performed by a UE, such as one of the examples UEs 120 described herein. In some implementations, the process 1100 may be performed by a wireless communication device, such as the wireless communication device 1400 or 1500 described with reference to FIGS. 14 and 15, respectively. For brevity, the example process 1100 is described as being performed by an apparatus that could be any of the above indicated UEs, wireless communication device, or a component thereof.

In block 1110, the apparatus may receive a system information broadcast (SIB) message from a first base station of a first radio access network (RAN). The SIB message may indicate whether the first RAN implements the first variant or a second variant of the first RAT. The second variant may be a forked deviation of the first variant.

In block 1120, the apparatus may establish a wireless connection with the first base station when the SIB message indicates that the first base station implements the first variant.

FIG. 11B shows a flowchart illustrating an example process 1102 in which a UE determines a variant of a RAT implemented by a base station based a radio resource control (RRC) message. The operations of the process 1102 may be implemented by a wireless communication device, a UE, or any component thereof as described herein. In some implementations, the process 1102 (or portions thereof) may be performed by a UE, such as one of the example UEs 120 described herein. In some implementations, the process 1102 may be performed by a wireless communication device, such as the wireless communication device 1400 or 1500 described with reference to FIGS. 14 and 15, respectively. For brevity, the example process 1102 is described as being performed by an apparatus that could be any of the above indicated UEs, wireless communication device, or a component thereof.

In block 1130, the apparatus may attempt to establish a wireless connection with a first base station of a first radio access network (RAN).

In block 1140, the apparatus may receive a radio resource control (RRC) message from the first base station.

In block 1150, the apparatus may disconnect the wireless connection with the first base station when the RRC message includes one or more indicia that the first base station implements a second variant. The second variant may be a forked deviation of the first variant.

FIG. 11C shows a flowchart illustrating an example process 1106 in which a UE determines a variant of a RAT implemented by a base station based on identification information of the RAN. The operations of the process 1106 may be implemented by a wireless communication device, a UE, or any component thereof as described herein. In some implementations, the process 1106 (or portions thereof) may be performed by a UE, such as one of the example UEs 120 described herein. In some implementations, the process 1106 may be performed by a wireless communication device, such as the wireless communication device 1400 or 1500 described with reference to FIGS. 14 and 15, respectively. For brevity, the example process 1106 is described as being performed by an apparatus that could be any of the above indicated UEs, wireless communication device, or a component thereof.

In block 1160, the apparatus may detect a signal from a first base station of a first RAN, the signal including identification information regarding the first RAN.

In block 1170, the apparatus may compare the identification information with compatibility information that identifies one or more RANs that implement the first variant or a second variant of the first RAT. The second variant may be a forked deviation of the first variant.

FIG. 12A shows a flowchart illustrating an example process 1200 in which a base station indicates a variant of a RAT implemented by the base station using system information broadcast (SIB) message. The operations of the process 1200 may be implemented by a wireless communication device, a base station, or any component thereof as described herein. In some implementations, the process 1200 (or portions thereof) may be performed by a base station, such as any one of the example base stations 110, 310, 350, 360, 510, 520, or 530 described herein. In some implementations, the process 1200 may be performed by a wireless communication device, such as the wireless communication device 1400 or 1500 described with reference to FIGS. 14 and 15, respectively. For brevity, the example process 1200 is described as being performed by an apparatus that could be any of the above indicated base stations, wireless communication device, or a component thereof. In block 1210, the apparatus may transmit a system information broadcast (SIB) message that indicates whether the first RAN implements a first variant or a second variant of the first RAT. The second variant may be a forked deviation of the first variant.

FIG. 12A shows a flowchart illustrating an example process 1202 in which a base station rejects a connection request from a UE that implements an incompatible variant of the RAT. The operations of the process 1202 may be implemented by a wireless communication device, a base station, or any component thereof as described herein. In some implementations, the process 1202 (or portions thereof) may be performed by a base station, such as any one of the example base stations 110, 310, 350, 360, 510, 520, or 530 described herein. In some implementations, the process 1202 may be performed by a wireless communication device, such as the wireless communication device 1400 or 1500 described with reference to FIGS. 14 and 15, respectively. For brevity, the example process 1202 is described as being performed by an apparatus that could be any of the above indicated base stations, wireless communication device, or a component thereof.

In block 1220, the apparatus may receive a request from a user equipment (UE) to establish a wireless connection with the apparatus.

In block 1230, the apparatus may reject the request when the apparatus and the UE implement different ones of a first variant and a second variant of the first RAT. The second variant may be a forked deviation of the first variant.

FIG. 13 shows a flowchart illustrating an example process 1300 in which a core network rejects a connection request from a UE that implements an incompatible variant of the RAT. The operations of the process 1300 may be implemented by a core network, or any component thereof as described herein. In some implementations, the process 1300 (or portions thereof) may be performed by a component of a core network, such as the 5GC 470 or the EPC 430 described herein. In some implementations, the process 1300 may be performed by a wireless communication device, such as the wireless communication device 1400 or 1500 described with reference to FIGS. 14 and 15, respectively. For brevity, the example process 1300 is described as being performed by an apparatus that could be any of the above indicated core networks or a component thereof.

In block 1310, the apparatus may receive a non-access stratum (NAS) registration request message from a user equipment (UE) via a first base station of the first RAN. In block 1320, the apparatus may transmit a NAS registration rejection message to the UE via the first base station when the first RAN and the UE implement different ones of a first variant and a second variant of the first RAT. The second variant may be a forked deviation of the first variant.

FIG. 14 shows a block diagram of an example wireless communication device. In some implementations, the wireless communication device 1400 can be an example of a device for use in a UE, such as the UE 120 described herein. The wireless communication device 1400 is capable of transmitting (or outputting for transmission) and receiving wireless communications.

The wireless communication device 1400 can be, or can include, a chip, system on chip (SoC), chipset, package or device. The term “system-on-chip” (SoC) is used herein to refer to a set of interconnected electronic circuits typically, but not exclusively, including one or more processors, a memory, and a communication interface. The SoC may include a variety of different types of processors and processor cores, such as a general purpose processor, a central processing unit (CPU), a digital signal processor (DSP), a graphics processing unit (GPU), an accelerated processing unit (APU), a sub-system processor, an auxiliary processor, a single-core processor, and a multicore processor. The SoC may further include other hardware and hardware combinations, such as a field programmable gate array (FPGA), a configuration and status register (CSR), an application-specific integrated circuit (ASIC), other programmable logic device, discrete gate logic, transistor logic, registers, performance monitoring hardware, watchdog hardware, counters, and time references. SoCs may be integrated circuits (ICs) configured such that the components of the IC reside on the same substrate, such as a single piece of semiconductor material (such as, for example, silicon).

The term “system in a package” (SIP) is used herein to refer to a single module or package that may contain multiple resources, computational units, cores or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SoCs coupled together via high speed communication circuitry and packaged in close proximity, such as on a single motherboard or in a single mobile communication device. The proximity of the SoCs facilitates high speed communications and the sharing of memory and resources.

The term “multicore processor” is used herein to refer to a single IC chip or chip package that contains two or more independent processing cores (for example a CPU core, IP core, GPU core, among other examples) configured to read and execute program instructions. An SoC may include multiple multicore processors, and each processor in an SoC may be referred to as a core. The term “multiprocessor” may be used herein to refer to a system or device that includes two or more processing units configured to read and execute program instructions.

The wireless communication device 1400 may include one or more modems 1402. In some implementations, the one or more modems 1402 (collectively “the modem 1402”) may include a wireless wide area network (WWAN) modem (for example, a 3GPP 4G LTE or 5G compliant modem). In some implementations, the wireless communication device 1400 also includes one or more radios (collectively “the radio 1404”). In some implementations, the wireless communication device 1400 further includes one or more processors, processing blocks or processing elements (collectively “the processing system 1406”) and one or more memory blocks or elements (collectively “the memory 1408”). In some implementations, the processing system 1406 can include the memory 1408.

The modem 1402 can include an intelligent hardware block or device such as, for example, an application-specific integrated circuit (ASIC) among other possibilities. The modem 1402 is generally configured to implement a physical (PHY) layer. For example, the modem 1402 is configured to modulate packets and to output the modulated packets to the radio 1404 for transmission over the wireless medium. The modem 1402 is similarly configured to obtain modulated packets received by the radio 1404 and to demodulate the packets to provide demodulated packets. In addition to a modulator and a demodulator, the modem 1402 may further include digital signal processing (DSP) circuitry, automatic gain control (AGC), a coder, a decoder, a multiplexer and a demultiplexer. For example, while in a transmission mode, data obtained from the processing system 1406 is provided to a coder, which encodes the data to provide encoded bits. The encoded bits are mapped to points in a modulation constellation (using a selected MCS) to provide modulated symbols. The modulated symbols may be mapped to a number NSS of spatial streams or a number NSTS of space-time streams. The modulated symbols in the respective spatial or space-time streams may be multiplexed, transformed via an inverse fast Fourier transform (IFFT) block, and subsequently provided to the DSP circuitry for Tx windowing and filtering. The digital signals may be provided to a digital-to-analog converter (DAC). The resultant analog signals may be provided to a frequency upconverter, and ultimately, the radio 1404. In implementations involving beamforming, the modulated symbols in the respective spatial streams are precoded via a steering matrix prior to their provision to the IFFT block.

While in a reception mode, digital signals received from the radio 1404 are provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also is coupled with the demodulator, which is configured to extract modulated symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits from all of the spatial streams are fed to the demultiplexer for demultiplexing. The demultiplexed bits may be descrambled and provided to a media access control (MAC) layer (the processing system 1406) for processing, evaluation, or interpretation.

The radio 1404 generally includes at least one radio frequency (RF) transmitter (or “transmitter chain”) and at least one RF receiver (or “receiver chain”), which may be combined into one or more transceivers. For example, the RF transmitters and receivers may include various DSP circuitry including at least one power amplifier (PA) and at least one low-noise amplifier (LNA), respectively. The RF transmitters and receivers may, in turn, be coupled to one or more antennas. For example, in some implementations, the wireless communication device 1400 can include, or be coupled with, multiple transmit antennas (each with a corresponding transmit chain) and multiple receive antennas (each with a corresponding receive chain). The symbols output from the modem 1402 are provided to the radio 1404, which transmits the symbols via the coupled antennas. Similarly, symbols received via the antennas are obtained by the radio 1404, which provides the symbols to the modem 1402.

The processing system 1406 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processing system 1406 processes information received through the radio 1404 and the modem 1402, and processes information to be output through the modem 1402 and the radio 1404 for transmission through the wireless medium. In some implementations, the processing system 1406 may generally control the modem 1402 to cause the modem to perform various operations described above.

The memory 1408 can include tangible storage media such as random-access memory (RAM) or read-only memory (ROM), or combinations thereof. The memory 1408 also can store non-transitory processor- or computer-executable software (SW) code containing instructions that, when executed by the processing system 1406, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more modules of one or more computer programs.

FIG. 15 shows a block diagram of another example wireless communication device. In some implementations, the wireless communication device 1500 is configured to perform one or more of the processes 800, 900, 1100, 1102, 1106, 1200, 1202 and 1300 described above with reference to FIGS. 8, 9, 11A, 11B, 11C, 12A, 12B and 13, respectively. The wireless communication device 1500 may be an example implementation of the wireless communication device 1400 described above with reference to FIG. 14. For example, the wireless communication device 1500 can be a chip, SoC, chipset, package or device that includes at least one modem (for example, a Wi-Fi (IEEE 802.11) modem or a cellular modem such as the modem 1402), at least one processor (such as the processing system 1406), at least one radio (such as the radio 1404) and at least one memory (such as the memory 1408). In some implementations, the wireless communication device 1500 can be a device for use in a UE, such as one of the UEs 120 described herein. In some other implementations, the wireless communication device 1500 can be a UE that includes such a chip, SoC, chipset, package or device as well as at least one antenna.

The wireless communication device 1500 may include a variant determination module 1502, a protocol module 1506, a compatibility determination module 1508, and a connection management module 1510. Portions of one or more of the modules 1502, 1506 and 1510 may be implemented at least in part in hardware or firmware. For example, the protocol module 1506 may be implemented at least in part by a modem (such as the modem 1402). In some implementations, at least some of the modules 1502, 1506 and 1510 are implemented at least in part as software stored in a memory (such as the memory 1408). For example, portions of one or more of the modules 1502, 1506 and 1510 can be implemented as non-transitory instructions (or “code”) executable by a processor (such as the processing system 1406) to perform the functions or operations of the respective module.

The variant determination module 1502 may be configured to determine what variant of a RAT is implemented in a RAN. The variant determination module 1502 may determine the variant based on a system information broadcast message, an RRC protocol message, a memory of the wireless communication device 1500, or any combination thereof.

The protocol module 1506 may be configured to operate an RRC protocol. The protocol module 1506 may assist the variant determination module 1502 in determining what variant is implemented in the RAN based on contents of an RRC message.

The compatibility determination module 1508 may be configured to determine whether the variant implemented in the RAN is compatible with a variant implemented in the wireless communication device 1500.

The connection management module 1510 may be configured to manage the establishment of a wireless connection with the RAN based on a determination by the compatibility determination module 1508 that the RAN implements a compatible variant of the RAT. The connection management module 1510 may be configured to prevent or bar a wireless connection with the RAN based on a determination by the compatibility determination module 1508 that the RAN implements an incompatible variant of the RAT.

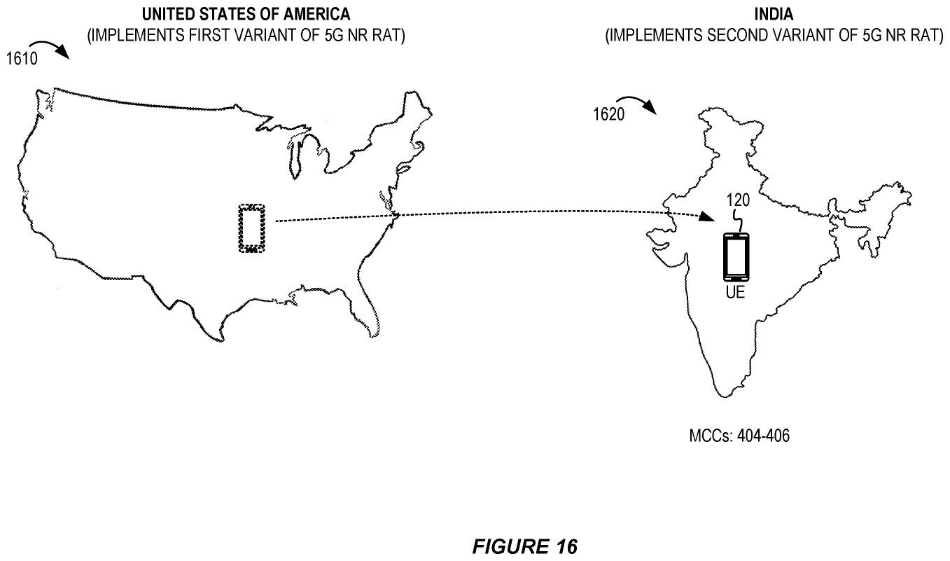

FIG. 16 shows a block diagram conceptually illustrating an example scenario in which a UE 120 travels to a geographic region that implements an incompatible variant of a 5G NR RAT. The example is based on a UE 120 that is associated with an HPLMN (not shown) in the United States of America (USA) 1610. The HPLMN may implement a first variant of 5G NR RAT that is based on 3GPP standard specification. Thus, the UE 120 may implement the 3GPP-compliant variant of the 5G NR RAT. When a user of the UE 120 travels to India 1620, the UE 120 may attempt to connect with a VPLMN in India 1620.

Meanwhile, the VPLMNs in India 1620 may implement a second variant of the 5G NR RAT. The second variant may be based on a forked deviation of the 3GPP standard specification that includes some other features adopted by the national SDO in India. For example, the second variant of 5G NR RAT may include one or more incompatible features that are not defined in the 3GPP variant of the 5G NR RAT. Examples of potentially incompatible features may include:
Configurable resource block group (RGB) size for a bandwidth part (BWP) (for NR)
MCS dependent phase tracking reference signal (PT-RS) density (for NR)
Faster sounding reference signal (SRS) precoder update (for NR)
Pi/2 binary phase shift keying (BPSK) with 1+D spectrum shaping and unfiltered demodulation reference signal (DMRS)
Pi/2 BPSK with 1+D spectrum shaping (for NB-IoT)

Although the second variant of the 5G NR RAT supports these example features, the UE 120 may implement a 3GPP-compliant variant of the 5G NR RAT that does not support these features. In some instances, absent the techniques of this disclosure, the UE 120 may attempt a connection and either experience delay or loss of connectivity as a result of not supporting the features that are incompatible with the first variant. In one scenario, the UE 120 may establish a radio connection but fail to establish a packet data session with the VPLMN. After some period of delay, the UE 120 may determine that the connection is unusable and may attempt another connection (potentially to another 5G NR RAN). The delay and successive connection failures may diminish user experience.

Using the techniques of this disclosure, the UE 120 may determine that the VPLMNs in India 1620 implement the incompatible variant of the 5G NR RAT. For example, the UE 120 may receive indicia in the RRC signaling to configure the potentially incompatible features. Alternatively, or additionally, the UE 120 may determine a PLMN ID or MCC that suggests the UE 120 is in India 1620. As an example, the PLMNs in India may be related to a set or range of MCCs (such as 404-406). Alternatively, or additionally, the UE 120 may determine its location based on satellite navigation signals, location-based services, or other indicia.

In a scenario in which use of the incompatible features is mandated, any VPLMN (not shown) that the UE 120 encounters in India 1620 may operate the second variant of the 5G NR RAT. The UE 120 may refrain from attempting to connect using 5G NR RAT in India 1620 and instead may connect to a 4G or 3G RAT. For example, the UE 120 may refrain from using 5G NR RAT for any VPLMN associated with an MCC from 404-406. Thus, after discovering that the UE 120 is in a geographic territory that implements an incompatible variant of 5G NR RAT, the UE 120 may prevent further delays or connection failures associated with the incompatible variant of 5G NR RAT.

FIGS. 1-16 and the operations described herein are examples meant to aid in understanding example implementations and should not be used to limit the potential implementations or limit the scope of the claims. Some implementations may perform additional operations, fewer operations, operations in parallel or in a different order, and some operations differently.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes. Alternatively, or in addition to the other examples described herein, examples include any combination of the following implementation options (enumerated as clauses for clarity).

### CLAUSES

Clause 1. A method by a user equipment (UE) that implements a first variant of a first radio access technology (RAT), including: receiving a system information broadcast (SIB) message from a first base station of a first radio access network (RAN), the SIB message indicating whether the first RAN implements the first variant or a second variant of the first RAT, where the second variant is a forked deviation of the first variant; and establishing a wireless connection with the first base station when the SIB message indicates that the first base station implements the first variant.

Clause 2. The method of clause 1, further including: refraining from establishing the wireless connection with the first base station when the SIB message indicates that the first base station implements the second variant.

Clause 3. The method of any one of clauses 1-2, further including: refraining from establishing the wireless connection with any base station of the first RAN when the SIB message indicates that the first base station implements the second variant.

Clause 4. The method of any one of clauses 1-3, further including: storing, in a memory of the UE, compatibility information regarding the first RAN based, at least in part, on whether the first RAN implements the first variant or the second variant.

Clause 5. The method of any one of clauses 1-4, further including: determining that the first RAN implements the second variant of the first RAT based, at least in part, on the SIB message; and establishing the wireless connection with a second RAN that implements the first variant of the first RAT or that implements a global variant of a second RAT.

Clause 6. The method of any one of clauses 1-5, where the SIB message includes one or more fields, at least a first field including an indication regarding whether the first RAN implements the first variant.

Clause 7. The method of any one of clauses 1-6, where the first RAT is a 5G New Radio (5G NR) access technology, where the first variant is compatible with a 3^{rd} Generation Partnership Project (3GPP) standards specification for the 5G NR access technology, and where the second variant is a standards specification that is partially compatible and partially incompatible with the 3GPP standards specification for the 5G NR access technology.

Clause 8. The method of clause 7, further including: establishing the wireless connection to a base station of a 4G RAN or a 3G RAN based on a determination that the UE is located in a geographic area that does not implement the 3GPP standards specification for the 5G NR access technology.

Clause 9. A method by a user equipment (UE) that implements a first variant of a first radio access technology (RAT), including: attempting to establish a wireless connection with a first base station of a first radio access network (RAN); receiving a radio resource control (RRC) message from the first base station; and disconnecting the wireless connection with the first base station when the RRC message includes one or more indicia that the first base station implements a second variant, where the second variant is a forked deviation of the first variant.

Clause 10. The method of clause 9, where the RRC message is an RRC configuration message, and where the one or more indicia includes one or more configuration elements for a feature that is not defined in the first variant of the first RAT.

Clause 11. The method of any one of clauses 9-10, where the RRC message is an RRC connection rejection message, and where the one or more indicia includes a reject code indicating that the first base station implements the second variant.

Clause 12. The method of any one of clauses 9-11, where the RRC message is an RRC redirection message, and where the one or more indicia includes a redirection code instructing the UE to establish the wireless connection to a base station that implements the first variant of the first RAT or that implements a global variant of a second RAT.

Clause 13. The method of any one of clauses 9-12, further including: refraining from establishing the wireless connection with any base station of the first RAN when the RRC configuration message includes one or more indicia that the first base station implements the second variant.

Clause 14. The method of any one of clauses 9-13, further including: storing, in a memory of the UE, compatibility information regarding the first RAN based, at least in part, on whether the first RAN implements the first variant or the second variant.

Clause 15. A method by a user equipment (UE) that implements a first variant of a first radio access technology (RAT), including: detecting a signal from a first base station of a first RAN, the signal including identification information regarding the first RAN; and comparing the identification information with compatibility information that identifies one or more RANs that implement the first variant or a second variant of the first RAT, where the second variant is a forked deviation of the first variant.

Clause 16. The method of clause 15, further including: determining whether to establish a wireless connection with the first base station based, at least in part, on whether the compatibility information indicates that the first RAN implements the first variant.

Clause 17. The method of any one of clauses 15-16, further including: establishing a wireless connection with the first base station; transmitting a non-access stratum (NAS) registration request message to a core network associated with the first RAN; and receiving a NAS registration rejection message from the core network, the NAS registration rejection message including the compatibility information.

Clause 18. The method of any one of clauses 15-17, where the NAS registration rejection message includes a rejection cause code that includes the compatibility information, and where the compatibility information includes one or more mobile country codes (MCCs) that implement the second variant of the first RAT, the method further including excluding one or more base stations of one or more RANs associated with the one or more MCCs that implement the second variant of the first RAT from a cell selection/reselection procedure.

Clause 19. The method of any one of clauses 15-18, further including: performing a cell selection/reselection procedure that includes the first base station when the compatibility information indicates that the first RAN implements the first variant of the first RAT.

Clause 20. The method of any one of clauses 15-19, further including: excluding the first base station from a cell selection/reselection procedure when the compatibility information indicates that the first RAN implements the second variant of the first RAT.

Clause 21. The method of any one of clauses 15-20, further including: obtaining the compatibility information from a memory of a subscriber identify module (SIM) in the UE.

Clause 22. The method of any one of clauses 15-21, where the compatibility information includes one or more mobile country codes (MCCs) for a geographic region that supports either the first variant or the second variant of the first RAT.

Clause 23. An apparatus in a user equipment (UE) that implements a first variant of a first radio access technology (RAT), including: at least one interface configured to obtain a system information broadcast (SIB) message from a first base station of a first radio access network (RAN); and a processing system configured to: determine whether the first RAN implements the first variant or a second variant of the first RAT based on the SIB message, where the second variant is a forked deviation of the first variant, and cause the at least one interface to establish a wireless connection with the first base station when the SIB message indicates that the first base station implements the first variant.

Clause 24. The apparatus of clause 23, where the processing system is further configured to cause the at least one interface to refrain from establishing the wireless connection with the first base station when the SIB message indicates that the first base station implements the second variant.

Clause 25. The apparatus of any one of clauses 23-24, where the processing system is further configured to cause the at least one interface to refrain from establishing the wireless connection with any base station of the first RAN when the SIB message indicates that the first base station implements the second variant.

Clause 26. The apparatus of any one of clauses 23-25, further including: a memory configured to store compatibility information regarding the first RAN based, at least in part, on whether the first RAN implements the first variant or the second variant.

Clause 27. The apparatus of any one of clauses 23-26, where the processing system is further configured to: determine that the first RAN implements the second variant of the first RAT based, at least in part, on the SIB message; and cause the at least one interface to establish the wireless connection with a second RAN that implements the first variant of the first RAT or that implements a global variant of a second RAT.

Clause 28. The apparatus of any one of clauses 23-27, where the SIB message includes one or more fields, at least a first field including an indication regarding whether the first RAN implements the first variant.

Clause 29. The apparatus of any one of clauses 23-28, where the first RAT is a 5G New Radio (5G NR) access technology, where the first variant is compatible with a 3^{rd} Generation Partnership Project (3GPP) standards specification for the 5G NR access technology, where the second variant is a standards specification that is partially compatible and partially incompatible with the 3GPP standards specification for the 5G NR access technology, and where the processing system is further configured to cause the at least one interface to establish the wireless connection to a base station of a 4G RAN or a 3G RAN based on a determination that the UE is located in a geographic area that does not implement the 3GPP standards specification for the 5G NR access technology.

Clause 30. An apparatus by a user equipment (UE) that implements a first variant of a first radio access technology (RAT), including: at least one interface configured to: attempt to establish a wireless connection with a first base station of a first radio access network (RAN), and obtain a radio resource control (RRC) message from the first base station; and a processing system configured to cause the at least one interface to disconnect the wireless connection with the first base station when the RRC message includes one or more indicia that the first base station implements a second variant, where the second variant is a forked deviation of the first variant.

Clause 31. The apparatus of clause 30, where the RRC message is an RRC configuration message, and where the one or more indicia includes one or more configuration elements for a feature that is not defined in the first variant of the first RAT.

Clause 32. The apparatus of any one of clauses 30-31, where the RRC message is an RRC connection rejection message, and where the one or more indicia includes a reject code indicating that the first base station implements the second variant.

Clause 33. The apparatus of any one of clauses 30-32, where the RRC message is an RRC redirection message, and where the one or more indicia includes a redirection code instructing the UE to establish the wireless connection to a base station that implements the first variant of the first RAT or that implements a global variant of a second RAT.

Clause 34. The apparatus of any one of clauses 30-33, where the processing system is further configured to cause the at least one interface to refrain from establishing the wireless connection with any base station of the first RAN when the RRC configuration message includes one or more indicia that the first base station implements the second variant.

Clause 35. The apparatus of any one of clauses 30-34, further including: a memory configured to store compatibility information regarding the first RAN based, at least in part, on whether the first RAN implements the first variant or the second variant.

Clause 36. An apparatus by a user equipment (UE) that implements a first variant of a first radio access technology (RAT), including: at least one interface configured to detect a signal from a first base station of a first RAN, the signal including identification information regarding the first RAN; and a processing system configured to compare the identification information with compatibility information that identifies one or more RANs that implement the first variant or a second variant of the first RAT, where the second variant is a forked deviation of the first variant.

Clause 37. The apparatus of clause 36, where the processing system is configured to determine whether to cause the at least one interface to establish a wireless connection with the first base station based, at least in part, on whether the compatibility information indicates that the first RAN implements the first variant.

Clause 38. The apparatus of any one of clauses 36-37, where the at least one interface is configured to: establish a wireless connection with the first base station; output a non-access stratum (NAS) registration request message for transmission to a core network via wireless connection; and obtain a NAS registration rejection message from the core network, the NAS registration rejection message including the compatibility information.

Clause 39. The apparatus of any one of clauses 36-38, where the NAS registration rejection message includes a rejection cause code that includes the compatibility information, where the compatibility information includes one or more mobile country codes (MCCs) that implement the second variant of the first RAT, and where the processing system is further configured to exclude one or more base stations of one or more RANs associated with the one or more MCCs that implement the second variant of the first RAT from a cell selection/reselection procedure.

Clause 40. The apparatus of any one of clauses 36-39, where the processing system is further configured to perform a cell selection/reselection procedure that includes the first base station when the first RAN implements the first variant of the first RAT.

Clause 41. The apparatus of any one of clauses 36-40, where the processing system is further configured to exclude the first base station from a cell selection/reselection procedure when the first RAN implements the second variant of the first RAT.

Clause 42. The apparatus of any one of clauses 36-41, where the compatibility information includes one or more mobile country codes (MCCs) for a geographic region that supports either the first variant or the second variant of the first RAT.

Clause 43. A method by a base station (gNB) of a first radio access network (RAN) that implements a first radio access technology (RAT), including: transmitting a system information broadcast (SIB) message that indicates whether the first RAN implements a first variant or a second variant of the first RAT, where the second variant is a forked deviation of the first variant.

Clause 44. The method of clause 43, further including: establishing a wireless connection with a first user equipment (UE) when both the gNB and the first UE implements a same one of the first variant or the second variant.

Clause 45. The method of any one of clauses 43-44, further including: rejecting a request from a first user equipment (UE) to establish a wireless connection with gNB when the gNB and the first UE implements different ones of the first variant and the second variant.

Clause 46. The method of any one of clauses 43-45, where rejecting the request includes transmitting a radio resource control (RRC) message that includes a reject code or a redirection code.

Clause 47. The method of any one of clauses 43-46, further including: receiving the request from the first UE; determining that the first UE implements a different one of the first variant and the second variant than is implemented by the gNB; and transmitting the RRC message with the reject code indicating that first UE and the gNB implement different ones of the first variant and the second variant.

Clause 48. The method of any one of clauses 43-47, where determining that the first UE implements the different one of the first variant and the first variant includes: determining that the first UE is associated with a first core network that is different from a second core network associated with the gNB; and determining that the first core network operates RANs that implement the different one of the first variant and the second variant than is implemented by the first RAN.

Clause 49. The method of any one of clauses 43-48, where the RRC message includes the redirection code instructing the first UE to establish the wireless connection to: a different base station (gNB) that implements a same one of the first variant or the second variant that is implemented by the first UE, or a legacy base station (eNB) that implements a global variant of a second RAT.

Clause 50. A method by a base station (gNB) of a first radio access network (RAN) that implements a first radio access technology (RAT), including: receiving a request from a user equipment (UE) to establish a wireless connection with gNB; and rejecting the request when the gNB and the UE implement different ones of a first variant and a second variant of the first RAT, where the second variant is a forked deviation of the first variant.

Clause 51. The method of clause 50, further including: establishing the wireless connection when both the gNB and the UE implements a same one of the first variant or the second variant.

Clause 52. The method of any one of clauses 50-51, where rejecting the request includes: transmitting a radio resource control (RRC) connection rejection message with a reject code indicating that gNB and the UE implement different ones of the first variant and the second variant.

Clause 53. The method of any one of clauses 50-52, where rejecting the request includes: transmitting a radio resource control (RRC) redirection message with a redirection code instructing the UE to establish the wireless connection to: a different base station (gNB) that implements a same one of the first variant or the second variant that is implemented by the first UE, or a legacy base station (eNB) that implements a global variant of a second RAT.

Clause 54. The method of any one of clauses 50-53, where rejecting the request includes: receiving a non-access stratum (NAS) registration request message from the UE via the wireless connection; transmitting the NAS registration request message to a core network associated with the gNB; obtaining a NAS registration rejection message from the core network, the NAS registration rejection message including a cause code with compatibility information that identifies one or more RANs that implement the first variant or the second variant of the first RAT; and transmitting the NAS registration rejection message to the UE via the wireless connection.

Clause 55. The method of any one of clauses 50-54, where the compatibility information includes one or more mobile country codes (MCCs) for a geographic region that supports either the first variant or the second variant of the first RAT.

Clause 56. A method by a core network of a first radio access network (RAN) that implements a first radio access technology (RAT), including: receiving a non-access stratum (NAS) registration request message from a user equipment (UE) via a first base station of the first RAN; and transmitting a NAS registration rejection message to the UE via the first base station when the first RAN and the UE implement different ones of a first variant and a second variant of the first RAT, where the second variant is a forked deviation of the first variant.

Clause 57. The method of clause 56, where the core network is part of a Visiting Public Land Mobile Network (VPLMN) that is different from a Home Public Land Mobile Network (HPLMN) of the UE, the method further including: determining that the HPLMN implements the first variant of the first RAT and that the VPLMN implements the second variant of the first RAT based, at least in part on a communication between the core network of the VPLMN with a component of the HPLMN.

Clause 58. The method of any one of clauses 56-57, where the NAS registration rejection message includes a cause code with compatibility information that identifies one or more RANs that implement the first variant or the second variant of the first RAT.

Clause 59. The method of any one of clauses 56-58, where the compatibility information includes one or more mobile country codes (MCCs) for a geographic region that supports either the first variant or the second variant of the first RAT.

Clause 60. An apparatus by a base station (gNB) of a first radio access network (RAN) that implements a first radio access technology (RAT), including: at least one interface configured to output a system information broadcast (SIB) message for transmission via a wireless channel, where the SIB message indicates whether the first RAN implements a first variant or a second variant of the first RAT, where the second variant is a forked deviation of the first variant.

Clause 61. The apparatus of clause 60, further including: a processing system configured to establish a wireless connection with a first user equipment (UE) when both the gNB and the first UE implements a same one of the first variant or the second variant.

Clause 62. The apparatus of any one of clauses 60-61, further including: a processing system configured to reject a request from a first user equipment (UE) to establish a wireless connection with gNB when the gNB and the first UE implements different ones of the first variant and the second variant.

Clause 63. The apparatus of any one of clauses 60-62, where the processing system is configured to reject the request by causing the at least one interface to output a radio resource control (RRC) message that includes a reject code or a redirection code.

Clause 64. The apparatus of any one of clauses 60-63, further including: the at least one interface configured to obtain the request from the first UE; the processing system configured to determine that the first UE implements a different one of the first variant and the second variant than is implemented by the gNB; and the at least one interface configured to output the RRC message with the reject code indicating that first UE and the gNB implement different ones of the first variant and the second variant.

Clause 65. The apparatus of any one of clauses 60-64, where the processing system is configured to: determine that the first UE is associated with a first core network that is different from a second core network associated with the gNB; and determine that the first core network operates RANs that implement the different one of the first variant and the second variant than is implemented by the first RAN.

Clause 66. The apparatus of any one of clauses 60-65, where the RRC message includes the redirection code instructing the first UE to establish the wireless connection to: a different base station (gNB) that implements a same one of the first variant or the second variant that is implemented by the first UE, or a legacy base station (eNB) that implements a global variant of a second RAT.

Clause 67. An apparatus by a base station (gNB) of a first radio access network (RAN) that implements a first radio access technology (RAT), including: at least one interface configured to obtain a request from a user equipment (UE) to establish a wireless connection with gNB; and a processing system configured to reject the request when the gNB and the UE implement different ones of a first variant and a second variant of the first RAT, where the second variant is a forked deviation of the first variant.

Clause 68. The apparatus of clause 67, further including: the processing system configured to establish the wireless connection when both the gNB and the UE implements a same one of the first variant or the second variant.

Clause 69. The apparatus of any one of clauses 67-68, further including: the at least one interface configured to output a radio resource control (RRC) connection rejection message with the reject code indicating that gNB and the UE implement different ones of the first variant and the second variant.

Clause 70. The apparatus of any one of clauses 67-69, further including: the at least one interface configured to output a radio resource control (RRC) redirection message with the redirection code instructing the UE to establish the wireless connection to: a different base station (gNB) that implements a same one of the first variant or the second variant that is implemented by the first UE, or a legacy base station (eNB) that implements a global variant of a second RAT.

Clause 71. The apparatus of any one of clauses 67-70, where the at least one interface is configured to: obtain a non-access stratum (NAS) registration request message from the UE via the wireless connection; provide the NAS registration request message to a core network associated with the gNB; obtain a NAS registration rejection message from the core network, the NAS registration rejection message including a cause code with compatibility information that identifies one or more RANs that implement the first variant or the second variant of the first RAT; and output the NAS registration rejection message for transmission to the UE via the wireless connection.

Clause 72. The apparatus of any one of clauses 67-71, where the compatibility information includes one or more mobile country codes (MCCs) for a geographic region that supports either the first variant or the second variant of the first RAT.

Clause 73. An apparatus by a core network of a first radio access network (RAN) that implements a first radio access technology (RAT), including at least one interface in coordination with at least one processing system configured to: obtain a non-access stratum (NAS) registration request message from a user equipment (UE) via a first base station of the first RAN; and output a NAS registration rejection message to the UE via the first base station when the first RAN and the UE implement different ones of a first variant and a second variant of the first RAT, where the second variant is a forked deviation of the first variant.

Clause 74. The apparatus of clause 73, where the core network is part of a Visiting Public Land Mobile Network (VPLMN) that is different from a Home Public Land Mobile Network (HPLMN) of the UE, the apparatus further including: the at least one processing system configured to determine that the HPLMN implements the first variant of the first RAT and that the VPLMN implements the second variant of the first RAT based, at least in part on a communication between the core network of the VPLMN with a component of the HPLMN.

Clause 75. The apparatus of any one of clauses 73-74, where the NAS registration rejection message includes a cause code with compatibility information that identifies one or more RANs that implement the first variant or the second variant of the first RAT.

Clause 76. The apparatus of any one of clauses 73-75, where the compatibility information includes one or more mobile country codes (MCCs) for a geographic region that supports either the first variant or the second variant of the first RAT.

Clause 77. A system of a user equipment (UE) that implements a first variant of a first radio access technology (RAT), including: means for receiving a system information broadcast (SIB) message from a first base station of a first radio access network (RAN), the SIB message indicating whether the first RAN implements the first variant or a second variant of the first RAT, where the second variant is a forked deviation of the first variant; and means for establishing a wireless connection with the first base station when the SIB message indicates that the first base station implements the first variant.

Clause 78. The system of clause 77, further including: means for refraining from establishing the wireless connection with the first base station when the SIB message indicates that the first base station implements the second variant.

Clause 79. The system of any one of clauses 77-78, further including: means for refraining from establishing the wireless connection with any base station of the first RAN when the SIB message indicates that the first base station implements the second variant.

Clause 80. The system of any one of clauses 77-79, further including: means for storing, in a memory of the UE, compatibility information regarding the first RAN based, at least in part, on whether the first RAN implements the first variant or the second variant.

Clause 81. The system of any one of clauses 77-80, further including: means for determining that the first RAN implements the second variant of the first RAT based, at least in part, on the SIB message; and means for establishing the wireless connection with a second RAN that implements the first variant of the first RAT or that implements a global variant of a second RAT.

Clause 82. The system of any one of clauses 77-81, where the SIB message includes one or more fields, at least a first field including an indication regarding whether the first RAN implements the first variant.

Clause 83. The system of any one of clauses 77-82, where the first RAT is a 5G New Radio (5G NR) access technology, where the first variant is compatible with a 3^{rd} Generation Partnership Project (3GPP) standards specification for the 5G NR access technology, and where the second variant is a standards specification that is partially compatible and partially incompatible with the 3GPP standards specification for the 5G NR access technology.

Clause 84. The system of any one of clauses 77-83, further including: means for establishing the wireless connection to a base station of a 4G RAN or a 3G RAN based on a determination that the UE is located in a geographic area that does not implement the 3GPP standards specification for the 5G NR access technology.

Clause 85. A system of a user equipment (UE) that implements a first variant of a first radio access technology (RAT), including: means for attempting to establish a wireless connection with a first base station of a first radio access network (RAN); means for receiving a radio resource control (RRC) message from the first base station; and means for disconnecting the wireless connection with the first base station when the RRC message includes one or more indicia that the first base station implements a second variant, where the second variant is a forked deviation of the first variant.

Clause 86. The system of clause 85, where the RRC message is an RRC configuration message, and where the one or more indicia includes one or more configuration elements for a feature that is not defined in the first variant of the first RAT.

Clause 87. The system of any one of clauses 85-86, where the RRC message is an RRC connection rejection message, and where the one or more indicia includes a reject code indicating that the first base station implements the second variant.

Clause 88. The system of any one of clauses 85-87, where the RRC message is an RRC redirection message, and where the one or more indicia includes a redirection code instructing the UE to establish the wireless connection to a base station that implements the first variant of the first RAT or that implements a global variant of a second RAT.

Clause 89. The system of any one of clauses 85-88, further including: means for refraining from establishing the wireless connection with any base station of the first RAN when the RRC configuration message includes one or more indicia that the first base station implements the second variant.

Clause 90. The system of any one of clauses 85-89, further including: means for storing, in a memory of the UE, compatibility information regarding the first RAN based, at least in part, on whether the first RAN implements the first variant or the second variant.

Clause 91. A system of a user equipment (UE) that implements a first variant of a first radio access technology (RAT), including: means for detecting a signal from a first base station of a first RAN, the signal including identification information regarding the first RAN; and means for comparing the identification information with compatibility information that identifies one or more RANs that implement the first variant or a second variant of the first RAT, where the second variant is a forked deviation of the first variant.

Clause 92. The system of clause 91, further including: means for determining whether to establish a wireless connection with the first base station based, at least in part, on whether the compatibility information indicates that the first RAN implements the first variant.

Clause 93. The system of any one of clauses 91-92, further including: means for establishing a wireless connection with the first base station; means for transmitting a non-access stratum (NAS) registration request message to a core network associated with the first RAN; and means for receiving a NAS registration rejection message from the core network, the NAS registration rejection message including the compatibility information.

Clause 94. The system of any one of clauses 91-93, where the NAS registration rejection message includes a rejection cause code that includes the compatibility information, and where the compatibility information includes one or more mobile country codes (MCCs) that implement the second variant of the first RAT, the system further including means for excluding one or more base stations of one or more RANs associated with the one or more MCCs that implement the second variant of the first RAT from a cell selection/reselection procedure.

Clause 95. The system of any one of clauses 91-94, further including: means for performing a cell selection/reselection procedure that includes the first base station when the compatibility information indicates that the first RAN implements the first variant of the first RAT.

Clause 96. The system of any one of clauses 91-95, further including: means for excluding the first base station from a cell selection/reselection procedure when the compatibility information indicates that the first RAN implements the second variant of the first RAT.

Clause 97. The system of any one of clauses 91-96, where the memory is part of a subscriber identify module (SIM) in the UE.

Clause 98. The system of any one of clauses 91-97, where the compatibility information includes one or more mobile country codes (MCCs) for a geographic region that supports either the first variant or the second variant of the first RAT.

Clause 99. A system of a base station (gNB) of a first radio access network (RAN) that implements a first radio access technology (RAT), including: means for transmitting a system information broadcast (SIB) message that indicates whether the first RAN implements a first variant or a second variant of the first RAT, where the second variant is a forked deviation of the first variant.

Clause 100. The system of clause 99, further including: means for establishing a wireless connection with a first user equipment (UE) when both the gNB and the first UE implements a same one of the first variant or the second variant.

Clause 101. The system of any one of clauses 99-100, further including: means for rejecting a request from a first user equipment (UE) to establish a wireless connection with gNB when the gNB and the first UE implements different ones of the first variant and the second variant.

Clause 102. The system of any one of clauses 99-101, where the means for rejecting the request includes means for transmitting a radio resource control (RRC) message that includes a reject code or a redirection code.

Clause 103. The system of any one of clauses 99-102, further including: means for receiving the request from the first UE; means for determining that the first UE implements a different one of the first variant and the second variant than is implemented by the gNB; and means for transmitting the RRC message with the reject code indicating that first UE and the gNB implement different ones of the first variant and the second variant.

Clause 104. The system of any one of clauses 99-103, where the means for determining that the first UE implements the different one of the first variant and the first variant includes: means for determining that the first UE is associated with a first core network that is different from a second core network associated with the gNB; and means for determining that the first core network operates RANs that implement the different one of the first variant and the second variant than is implemented by the first RAN.

Clause 105. The system of any one of clauses 99-104, where the RRC message includes the redirection code instructing the first UE to establish the wireless connection to: a different base station (gNB) that implements a same one of the first variant or the second variant that is implemented by the first UE, or a legacy base station (eNB) that implements a global variant of a second RAT.

Clause 106. A system of a base station (gNB) of a first radio access network (RAN) that implements a first radio access technology (RAT), including: means for receiving a request from a user equipment (UE) to establish a wireless connection with gNB; and means for rejecting the request when the gNB and the UE implement different ones of a first variant and a second variant of the first RAT, where the second variant is a forked deviation of the first variant.

Clause 107. The system of clause 106, further including: means for establishing the wireless connection when both the gNB and the UE implements a same one of the first variant or the second variant.

Clause 108. The system of any one of clauses 106-107, where the means for rejecting the request includes: means for transmitting a radio resource control (RRC) connection rejection message with a reject code indicating that gNB and the UE implement different ones of the first variant and the second variant.

Clause 109. The system of any one of clauses 106-108, where the means for rejecting the request includes: means for transmitting a radio resource control (RRC) redirection message with a redirection code instructing the UE to establish the wireless connection to: a different base station (gNB) that implements a same one of the first variant or the second variant that is implemented by the first UE, or a legacy base station (eNB) that implements a global variant of a second RAT.

Clause 110. The system of any one of clauses 106-109, where the means for rejecting the request includes: means for receiving a non-access stratum (NAS) registration request message from the UE via the wireless connection; means for transmitting the NAS registration request message to a core network associated with the gNB; means for obtaining a NAS registration rejection message from the core network, the NAS registration rejection message including a cause code with compatibility information that identifies one or more RANs that implement the first variant or the second variant of the first RAT; and means for transmitting the NAS registration rejection message to the UE via the wireless connection.

Clause 111. The system of any one of clauses 106-110, where the compatibility information includes one or more mobile country codes (MCCs) for a geographic region that supports either the first variant or the second variant of the first RAT.

Clause 112. A system of a core network of a first radio access network (RAN) that implements a first radio access technology (RAT), including means for receiving a non-access stratum (NAS) registration request message from a user equipment (UE) via a first base station of the first RAN; and means for transmitting a NAS registration rejection message to the UE via the first base station when the first RAN and the UE implement different ones of a first variant and a second variant of the first RAT, where the second variant is a forked deviation of the first variant.

Clause 113. The system of clause 112, where the core network is part of a Visiting Public Land Mobile Network (VPLMN) that is different from a Home Public Land Mobile Network (HPLMN) of the UE, the system further including: means for determining that the HPLMN implements the first variant of the first RAT and that the VPLMN implements the second variant of the first RAT based, at least in part on a communication between the core network of the VPLMN with a component of the HPLMN.

Clause 114. The system of any one of clauses 112-113, where the NAS registration rejection message includes a cause code with compatibility information that identifies one or more RANs that implement the first variant or the second variant of the first RAT.

Clause 115. The system of any one of clauses 112-114, where the compatibility information includes one or more mobile country codes (MCCs) for a geographic region that supports either the first variant or the second variant of the first RAT.

Clause 116. A method for wireless communication by a user equipment (UE), including: receiving indicia that indicates whether a first base station is configured to operate according to a first variant of a first radio access technology (RAT) or a second variant of the first RAT; and establishing a wireless connection with the first base station when both the UE and the first base station are configured to operate according to a same one of the first variant or the second variant.

Clause 117. The method of clause 116, further including: refraining from establishing the wireless connection with the first base station when the UE and the first base station are configured to operate according to different ones of the first variant or the second variant.

Clause 118. The method of any one of clauses 116-117, where the first base station is part of a first radio access network (RAN), the method further including: refraining from establishing the wireless connection with any base station of the first RAN when the UE and the first base station are configured to operate according to different ones of the first variant or the second variant.

Clause 119. The method of any one of clauses 116-118, where receiving the indicia includes: receiving a system information broadcast (SIB) message that includes at least a first field carrying the indicia regarding whether the first base station is configured to operate according to the first variant or the second variant.

Clause 120. The method of any one of clauses 116-119, where receiving the indicia includes: receiving location data that indicates that the UE is located in a geographic area; and retrieving the indicia from compatibility information that correlates the geographic area in association with a standards specification for a particular one of the first variant or the second variant.

Clause 121. The method of any one of clauses 116-120, where receiving the indicia includes: attempting to establish the wireless connection with the first base station; receiving a radio resource control (RRC) message from the first base station; and retrieving the indicia from the RRC message.

Clause 122. The method of any one of clauses 116-121, where receiving the indicia includes at least one member of a group consisting of: receiving a radio resource control (RRC) configuration message that carries one or more configuration elements for a feature that is specific to a particular one of the first variant or the second variant; receiving an RRC connection rejection message that carries a reject code indicating that the first base station is configured to operate according to a different one of the first variant or the second variant than the UE; receiving an RRC redirection message that carries a redirection code instructing the UE to establish the wireless connection to a second base station that is configured to operate according to the same one of the first variant or the second variant as the UE; and receiving an RRC redirection message that carries a redirection code instructing the UE to establish the wireless connection to a second base station that is configured to operate according to a second RAT.

Clause 123. The method of any one of clauses 116-122, where receiving the indicia includes: receiving identification information from the first base station, identification information identifying a radio access network (RAN) that includes the first base station; and retrieving the indicia from compatibility information that correlates the identification information in association with either the first variant or the second variant.

Clause 124. The method of any one of clauses 116-123, where receiving the indicia includes: receiving a non-access stratum (NAS) message from a core network via the first base station or a second base station; retrieving the indicia from the NAS message.

Clause 125. The method of any one of clauses 116-124, further including: retrieving the indicia from compatibility information stored in a memory of the UE, where the compatibility information compatibility information that correlates a mobile country code (MCC) of the first base station in association with a geographic region, the compatibility information including one or more MCCs for respective geographic regions that supports either the first variant or the second variant of the first RAT.

Clause 126. The method of any one of clauses 116-125, further including: including the first base station in a cell selection/reselection procedure when both the UE and the first base station are configured to operate according to the same one of the first variant or the second variant; and excluding the first base station from the cell selection/reselection procedure when the UE and the first base station are configured to operate according to different ones of the first variant or the second variant.

Clause 127. The method of any one of clauses 116-126, where the first RAT is a 5G New Radio (5G NR) access technology, where the first variant is compatible with a 3^{rd} Generation Partnership Project (3GPP) standards specification for the 5G NR access technology, and where the second variant is a forked deviation of the first variant, the second variant based on a standards specification that is partially incompatible with the 3GPP standards specification for the 5G NR access technology.

Clause 128. A user equipment (UE), including: at least one modem for wireless communication with a first base station, the at least one modem configured to obtain indicia that indicates whether the first base station is configured to operate according to a first variant of a first radio access technology (RAT) or a second variant of the first RAT; and a processor configured to cause the at least one modem to establish a wireless connection with the first base station when both the UE and the first base station are configured to operate according to a same one of the first variant or the second variant.

Clause 129. The UE of clause 128, where the processor is further configured to cause the at least one modem to refrain from establishing the wireless connection with the first base station when the UE and the first base station are configured to operate according to different ones of the first variant or the second variant.

Clause 130. The UE of any one of clauses 128-129, where the first base station is part of a first radio access network (RAN), and where the processor is further configured to cause the at least one modem to refrain from establishing the wireless connection with any base station of the first RAN when the UE and the first base station are configured to operate according to different ones of the first variant or the second variant.

Clause 131. The UE of any one of clauses 128-130, where the at least one modem is configured to obtain a system information broadcast (SIB) message that includes at least a first field carrying the indicia regarding whether the first base station is configured to operate according to the first variant or the second variant.

Clause 132. The UE of any one of clauses 128-131, where the at least one modem is configured to obtain location data that indicates that the UE is located in a geographic area; and where the processor is configured to retrieve the indicia from compatibility information that correlates the geographic area in association with a standards specification for a particular one of the first variant or the second variant.

Clause 133. The UE of any one of clauses 128-132, where the at least one modem is configured to: attempt to establish the wireless connection with the first base station, and obtain a radio resource control (RRC) message from the first base station; and where the processor is configured to retrieve the indicia from the RRC message.

Clause 134. The UE of any one of clauses 128-133, where the at least one modem is configured to obtain identification information from the first base station, identification information identifying a radio access network (RAN) that includes the first base station; and where the processor is configured to retrieve the indicia from compatibility information that correlates the identification information in association with either the first variant or the second variant.

Clause 135. The UE of any one of clauses 128-134, where the at least one modem is configured to obtain a non-access stratum (NAS) message from a core network via the first base station or a second base station; and where the processor is configured to retrieve the indicia from the NAS message.

Clause 136. The UE of any one of clauses 128-135, where the processor is configured retrieve the indicia from compatibility information stored in a memory of the UE, where the compatibility information compatibility information that correlates a mobile country code (MCC) of the first base station in association with a geographic region, the compatibility information including one or more MCCs for respective geographic regions that supports either the first variant or the second variant of the first RAT

Clause 137. The UE of any one of clauses 128-136, at least one transceiver coupled to the at least one modem; at least one antenna coupled to the at least one transceiver to wirelessly transmit signals output from the at least one transceiver and to wirelessly receive signals for input into the at least one transceiver; and a housing that encompasses at least the processor, the at least one modem, the at least one transceiver, and at least a portion of the at least one antenna.

Clause 138. A method for wireless communication by a base station, including: transmitting indicia that indicates whether the base station is configured to operate according to a first variant of a first radio access technology (RAT) or a second variant of the first RAT; and establishing a wireless connection with the UE when both the UE and the base station are configured to operate according to a same one of the first variant or the second variant.

Clause 139. The method of clause 138, further including: rejecting a request from the UE to establish the wireless connection with base station when the base station and the first UE are configured to operate according to different ones of the first variant and the second variant.

Clause 140. The method of any one of clauses 138-139, where rejecting the request includes at least one member selected from a group consisting of: transmitting a system information broadcast (SIB) message that includes at least a first field carrying the indicia regarding whether the first base station is configured to operate according to the first variant or the second variant; transmitting a radio resource control (RRC) message that includes a reject code indicating that first UE and the gNB are configured to operate according to different ones of the first variant and the second variant; transmitting an RRC message that includes a redirection code instructing the first UE to establish the wireless connection to a different base station that is configured to operate according to the same one of the first variant or the second variant as the UE; transmitting an RRC message that includes a redirection code instructing the first UE to establish the wireless connection to a legacy base station that is configured to operate according to a second RAT; and transmitting a non-access stratum (NAS) message from a core network to the UE via the wireless connection, the NAS message carrying compatibility information that includes one or more mobile country codes (MCCs) associated with a geographic region and which variant of the first RAT is associated with the geographic region.

Clause 141. The method of any one of clauses 138-140, further including: receiving information that indicates the UE is associated with a first core network that is different from a second core network associated with the base station; and rejecting the request when the first core network and the second core network are associated with different ones of the first variant and the second variant.

Clause 142. The method of any one of clauses 138-141, further including: receiving information regarding a Home Public Land Mobile Network (HPLMN) of the UE, where the base station is acting as a Visiting Public Land Mobile Network (VPLMN) that is different from the HPLMN; and rejecting the request when the HPLMN and the VPLMN are configured to operate according to different ones of the first variant and the second variant.

Clause 143. The method of any one of clauses 138-142, further including: transmitting identification information to the UE, the identification information identifying a radio access network (RAN) that includes the first base station, where the identification information is usable by the UE with compatibility information that correlates the identification information in association with either the first variant or the second variant.

Clause 144. A base station, including: at least one modem configured to output indicia that indicates whether the base station is configured to operate according to a first variant of a first radio access technology (RAT) or a second variant of the first RAT; and a processor configured to establish a wireless connection with a user equipment (UE) via the at least one modem when both the UE and the base station are configured to operate according to a same one of the first variant or the second variant.

Clause 145. The base station of clause 144, at least one transceiver coupled to the at least one modem; at least one antenna coupled to the at least one transceiver to wirelessly transmit signals output from the at least one transceiver and to wirelessly receive signals for input into the at least one transceiver; and a housing that encompasses at least the processor, the at least one modem, the at least one transceiver, and at least a portion of the at least one antenna.

Another innovative aspect of the subject matter described in this disclosure can be implemented as an apparatus. The apparatus may include a modem and at least one processor communicatively coupled with the at least one modem. The processor, in conjunction with the modem, may be configured to perform any one of the above-mentioned methods or features described herein.

Another innovative aspect of the subject matter described in this disclosure can be implemented as a computer-readable medium having stored therein instructions which, when executed by a processor, causes the processor to perform any one of the above-mentioned methods or features described herein.

Another innovative aspect of the subject matter described in this disclosure can be implemented as a system having means for implementing any one of the above-mentioned methods or features described herein.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.”

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, or the like.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

As used herein, the terms “user equipment”, “wireless communication device”, “mobile communication device”, “communication device”, or “mobile device” refer to any one or all of cellular telephones, smartphones, portable computing devices, personal or mobile multi-media players, laptop computers, tablet computers, smartbooks, Internet-of-Things (IoT) devices, palm-top computers, wireless electronic mail receivers, multimedia Internet enabled cellular telephones, wireless gaming controllers, display sub-systems, driver assistance systems, vehicle controllers, vehicle system controllers, vehicle communication system, infotainment systems, vehicle telematics systems or subsystems, vehicle display systems or subsystems, vehicle data controllers or routers, and similar electronic devices which include a programmable processor and memory and circuitry configured to perform operations as described herein.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, or other information used to identify or authenticate a mobile communication device on a network and enable a communication service with the network. Because the information stored in a SIM enables the mobile communication device to establish a communication link for a particular communication service with a particular network, the term “subscription” is used herein as a shorthand reference to refer to the communication service associated with and enabled by the information stored in a particular SIM as the SIM and the communication network, as well as the services and subscriptions supported by that network, correlate to one another. A SIM used in various examples may contain user account information, an international mobile subscriber identity (IMSI), a set of SIM application toolkit (SAT) commands, and storage space for phone book contacts. A SIM card may further store home identifiers (such as, a System Identification Number (SID)/Network Identification Number (NID) pair, a Home Public Land Mobile Number (HPLMN) code, among other examples) to indicate the SIM card network operator provider. An Integrated Circuit Card Identity (ICCID) SIM serial number may be printed on the SIM card for identification. However, a SIM may be implemented within a portion of memory of the mobile communication device, and thus need not be a separate or removable circuit, chip or card.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method for wireless communication by a user equipment (UE), comprising:
receiving indicia that indicates whether a first base station is configured to operate according to a first variant of a first radio access technology (RAT) or a second variant of the first RAT; and
establishing a wireless connection with the first base station when both the UE and the first base station are configured to operate according to a same one of the first variant or the second variant.

2. The method of claim 1, further comprising:
refraining from establishing the wireless connection with the first base station when the UE and the first base station are configured to operate according to different ones of the first variant or the second variant.

3. The method of claim 1, wherein the first base station is part of a first radio access network (RAN), the method further comprising:
refraining from establishing the wireless connection with any base station of the first RAN when the UE and the first base station are configured to operate according to different ones of the first variant or the second variant.

4. The method of claim 1, wherein receiving the indicia includes:
receiving a system information broadcast (SIB) message that includes at least a first field carrying the indicia regarding whether the first base station is configured to operate according to the first variant or the second variant.

5. The method of claim 1, wherein receiving the indicia includes:
receiving location data that indicates that the UE is located in a geographic area; and
retrieving the indicia from compatibility information that correlates the geographic area in association with a standards specification for a particular one of the first variant or the second variant.

6. The method of claim 1, wherein receiving the indicia includes:
attempting to establish the wireless connection with the first base station;
receiving a radio resource control (RRC) message from the first base station; and
retrieving the indicia from the RRC message.

7. The method of claim 1, wherein receiving the indicia includes at least one member of a group consisting of:
receiving a radio resource control (RRC) configuration message that carries one or more configuration elements for a feature that is specific to a particular one of the first variant or the second variant;
receiving an RRC connection rejection message that carries a reject code indicating that the first base station is configured to operate according to a different one of the first variant or the second variant than the UE;
receiving an RRC redirection message that carries a redirection code instructing the UE to establish the wireless connection to a second base station that is configured to operate according to the same one of the first variant or the second variant as the UE; and
receiving an RRC redirection message that carries a redirection code instructing the UE to establish the wireless connection to a second base station that is configured to operate according to a second RAT.

8. The method of claim 1, wherein receiving the indicia includes:
receiving identification information from the first base station, identification information identifying a radio access network (RAN) that includes the first base station; and
retrieving the indicia from compatibility information that correlates the identification information in association with either the first variant or the second variant.

9. The method of claim 1, wherein receiving the indicia includes:
receiving a non-access stratum (NAS) message from a core network via the first base station or a second base station; and
retrieving the indicia from the NAS message.

10. The method of claim 1, further comprising:
retrieving the indicia from compatibility information stored in a memory of the UE, wherein the compatibility information compatibility information that correlates a mobile country code (MCC) of the first base station in association with a geographic region, the compatibility information including one or more MCCs for respective geographic regions that supports either the first variant or the second variant of the first RAT.

11. The method of claim 1, further comprising:
including the first base station in a cell selection/reselection procedure when both the UE and the first base station are configured to operate according to the same one of the first variant or the second variant; and
excluding the first base station from the cell selection/reselection procedure when the UE and the first base station are configured to operate according to different ones of the first variant or the second variant.

12. The method of claim 1,
wherein the first RAT is a 5G New Radio (5G NR) access technology,
wherein the first variant is compatible with a 3^{rd} Generation Partnership Project (3GPP) standards specification for the 5G NR access technology, and
wherein the second variant is a forked deviation of the first variant, the second variant based on a standards specification that is partially incompatible with the 3GPP standards specification for the 5G NR access technology.

13. A user equipment (UE), comprising:
at least one modem for wireless communication with a first base station, the at least one modem configured to obtain indicia that indicates whether the first base station is configured to operate according to a first variant of a first radio access technology (RAT) or a second variant of the first RAT; and
a processor configured to cause the at least one modem to establish a wireless connection with the first base station when both the UE and the first base station are configured to operate according to a same one of the first variant or the second variant.

14. The UE of claim 13, wherein the processor is further configured to cause the at least one modem to refrain from establishing the wireless connection with the first base station when the UE and the first base station are configured to operate according to different ones of the first variant or the second variant.

15. The UE of claim 13, wherein the first base station is part of a first radio access network (RAN), and wherein the processor is further configured to cause the at least one modem to refrain from establishing the wireless connection with any base station of the first RAN when the UE and the first base station are configured to operate according to different ones of the first variant or the second variant.

16. The UE of claim 13, wherein the at least one modem is configured to obtain a system information broadcast (SIB) message that includes at least a first field carrying the indicia regarding whether the first base station is configured to operate according to the first variant or the second variant.

17. The UE of claim 13,
wherein the at least one modem is configured to obtain location data that indicates that the UE is located in a geographic area; and
wherein the processor is configured to retrieve the indicia from compatibility information that correlates the geographic area in association with a standards specification for a particular one of the first variant or the second variant.

18. The UE of claim 13,
wherein the at least one modem is configured to:
attempt to establish the wireless connection with the first base station, and
obtain a radio resource control (RRC) message from the first base station; and
wherein the processor is configured to retrieve the indicia from the RRC message.

19. The UE of claim 13,
wherein the at least one modem is configured to obtain identification information from the first base station, identification information identifying a radio access network (RAN) that includes the first base station; and
wherein the processor is configured to retrieve the indicia from compatibility information that correlates the identification information in association with either the first variant or the second variant.

20. The UE of claim 13,
wherein the at least one modem is configured to obtain a non-access stratum (NAS) message from a core network via the first base station or a second base station; and
wherein the processor is configured to retrieve the indicia from the NAS message.

21. The UE of claim 20, wherein the processor is configured retrieve the indicia from compatibility information stored in a memory of the UE, wherein the compatibility information compatibility information that correlates a mobile country code (MCC) of the first base station in association with a geographic region, the compatibility information including one or more MCCs for respective geographic regions that supports either the first variant or the second variant of the first RAT.

22. The UE of claim 13,
at least one transceiver coupled to the at least one modem;
at least one antenna coupled to the at least one transceiver to wirelessly transmit signals output from the at least one transceiver and to wirelessly receive signals for input into the at least one transceiver; and
a housing that encompasses at least the processor, the at least one modem, the at least one transceiver, and at least a portion of the at least one antenna.

23. A method for wireless communication by a base station, comprising:
transmitting indicia that indicates whether the base station is configured to operate according to a first variant of a first radio access technology (RAT) or a second variant of the first RAT; and
establishing a wireless connection with the UE when both the UE and the base station are configured to operate according to a same one of the first variant or the second variant.

24. The method of claim 23, further comprising:
rejecting a request from the UE to establish the wireless connection with base station when the base station and the first UE are configured to operate according to different ones of the first variant and the second variant.

25. The method of claim 24, wherein rejecting the request includes at least one member selected from a group consisting of:
transmitting a system information broadcast (SIB) message that includes at least a first field carrying the indicia regarding whether the first base station is configured to operate according to the first variant or the second variant;
transmitting a radio resource control (RRC) message that includes a reject code indicating that first UE and the gNB are configured to operate according to different ones of the first variant and the second variant;
transmitting an RRC message that includes a redirection code instructing the first UE to establish the wireless connection to a different base station that is configured to operate according to the same one of the first variant or the second variant as the UE;
transmitting an RRC message that includes a redirection code instructing the first UE to establish the wireless connection to a legacy base station that is configured to operate according to a second RAT; and
transmitting a non-access stratum (NAS) message from a core network to the UE via the wireless connection, the NAS message carrying compatibility information that includes one or more mobile country codes (MCCs) associated with a geographic region and which variant of the first RAT is associated with the geographic region.

26. The method of claim 24, further comprising:
receiving information that indicates the UE is associated with a first core network that is different from a second core network associated with the base station; and
rejecting the request when the first core network and the second core network are associated with different ones of the first variant and the second variant.

27. The method of claim 23, further comprising:
receiving information regarding a Home Public Land Mobile Network (HPLMN) of the UE, wherein the base station is acting as a Visiting Public Land Mobile Network (VPLMN) that is different from the HPLMN; and
rejecting the request when the HPLMN and the VPLMN are configured to operate according to different ones of the first variant and the second variant.

28. The method of claim 23, further comprising:
transmitting identification information to the UE, the identification information identifying a radio access network (RAN) that includes the first base station, wherein the identification information is usable by the UE with compatibility information that correlates the identification information in association with either the first variant or the second variant.

29. A base station, comprising:
at least one modem configured to output indicia that indicates whether the base station is configured to operate according to a first variant of a first radio access technology (RAT) or a second variant of the first RAT; and
a processor configured to establish a wireless connection with a user equipment (UE) via the at least one modem when both the UE and the base station are configured to operate according to a same one of the first variant or the second variant.

30. The base station of claim 29,
at least one transceiver coupled to the at least one modem;
at least one antenna coupled to the at least one transceiver to wirelessly transmit signals output from the at least one transceiver and to wirelessly receive signals for input into the at least one transceiver; and
a housing that encompasses at least the processor, the at least one modem, the at least one transceiver, and at least a portion of the at least one antenna.
